(19) United States
(12) Patent Application Publication
(10) Pub. No.: US 2024/0332614 A1
(43) Pub. Date: Oct. 3, 2024

(54) ELECTROLYTE COMPOSITIONS AND ELECTROCHEMICAL DEVICES THEREOF

(71) Applicant: Factorial Inc., Woburn, MA (US)

(72) Inventors: Yiqing Huang, Lexington, MA (US); Zhangxing Shi, Winchester, MA (US); Jia Du, Burlington, MA (US); Dong Ren, Woburn, MA (US)

(21) Appl. No.: 18/617,798

(22) Filed: Mar. 27, 2024

Related U.S. Application Data
(60) Provisional application No. 63/493,124, filed on Mar. 30, 2023.

(51) Int. Cl. H01M 10/0565; H01M 10/0568; H01M 10/0569; H01M 10/42

(52) U.S. Cl. CPC H01M 10/0565; H01M 10/0568; H01M 10/0569; H01M 2010/4292; H01M 2300/0034; H01M 2300/0037

(57) ABSTRACT

Provided herein are electrolyte compositions suitable for electrochemical devices such as batteries, capacitors, sensors, condensers, electrochromic elements, photoelectric conversion elements, and the like.

### CROSS-REFERENCE

The present application claims priority of U.S. Ser. No. 63/493,124, filed Mar. 30, 2023, the entire content of which is incorporated herein by reference into this application.

### TECHNICAL FIELD

This disclosure relates to electrolyte compositions suitable for electrochemical devices such as batteries, capacitors, sensors, condensers, electrochromic elements, photoelectric conversion elements, and the like.

### BACKGROUND

Battery technologies have transformed significantly over the past five decades. As the field of electrical energy storage continues to grow and be widely applied, the demand for lithium-ion battery (LIB) performance becomes higher and higher. Cycle life is pushed from thousands of cycles to a million cycles; energy density has advanced to approach 500 Wh/kg; the cost of high-performing batteries is incrementally decreasing, approaching as low as $100/Wh. With such high demand, the performance limit of current LIB system, i.e., lithium metal oxide cathode paired with a graphite anode in liquid carbonate electrolyte, is imminent and only minute improvements can be made to further its performance. However, as the energy density of LIBs become higher failure of LIBs packed with increased energy in a given space would cause more serious safety concerns.

Accompanying the rise of energy densities of lithium-ion batteries (LIBs) and the expansions of scale, finding a solution to the safety concerns of LIBs becomes more important. Safety issues existing in LIBs may arise from the use of mixed flammable solvents such as carbonate/ether, which, in the case of overcharging, short-circuiting, over-heating, etc. can lead to serious accidents from LIBs catching on fire, burning or even exploding.

### SUMMARY

The present disclosure generally relates to various electrolyte compositions. The subject matter of the present disclosure involves, in some cases, interrelated products, alternative solutions to a particular problem, and/or a plurality of different uses of one or more systems and/or articles.

In one aspect, electrolyte compositions are featured, comprising an electrolyte salt; a polymer; and a solvent comprising a fluorinated ether and a non-fluorinated ether.

In one aspect, electrolyte compositions are featured, comprising an electrolyte salt; a polymer; and a solvent comprising a non-fluorinated ether, wherein the electrolyte salt is present in an amount of about 30 wt % to about 75 wt %, based on the total weight of the electrolyte composition.

In one aspect, electrolyte compositions are featured, comprising an electrolyte salt; and a solvent comprising a fluorinated ether and a non-fluorinated ether, wherein the fluorinated ether has a boiling point of at least 100° C.

In one aspect, electrochemical devices are featured, comprising the electrolyte compositions of the disclosure.

In one aspect, electrochemical devices are featured, comprising an anode; a cathode; and an electrolyte composition of the disclosure; wherein the electrochemical device has a capacity retention of at least 70% at a temperature in a range of −10° C. to −20° C. for at least 6 hours.

In one aspect, electrochemical devices are featured, comprising an anode; a cathode; and an electrolyte composition of the disclosure, wherein the electrochemical device passes a hotbox test, wherein the electrochemical device is at 100% state-of-charge and is held at each of the following temperatures: 130° C., 140° C., 150° C., 160° C., 170° C., 180° C., and 190° C. for 10 minutes with a European Council for Automotive Research (EUCAR) hazard level of 4 or below.

In one aspect, electrochemical devices are featured, comprising an anode; a cathode; and an electrolyte composition of the disclosure, wherein the electrochemical device passes an overcharge test, wherein the electrochemical device is at 100% state-of-charge and is overcharged at a 3 mA/cm² charge rate for 1 hour or when 8.5V is reached with a European Council for Automotive Research (EUCAR) hazard level of 4 or below.

In one aspect, electrochemical devices are featured, comprising an anode; a cathode; and an electrolyte composition of the disclosure, wherein the electrochemical cell has a charge current density in a range of about 10.5 mAh/cm² to about 16.5 mAh/cm². In some embodiments, the electrolyte composition further comprises a polymer.

The term “% by weight” or “percent by weight” refers to the percentage the identified components or components represent with the percent calculated as percent by weight of all components excluding water, unless otherwise noted.

The term “alkyl” refers to a saturated acyclic hydrocarbon radical that may be a straight chain or branched chain, containing the indicated number of carbon atoms. For example, C₁₋₁₀ indicates that the group may have from 1 to 10 (inclusive) carbon atoms in it. Non-limiting examples include methyl, ethyl, iso-propyl, tert-butyl, n-hexyl. The term “saturated” as used in this context means only single bonds present between constituent carbon atoms and other available valences occupied by hydrogen and/or other substituents as defined herein.

The term “halogen” refers to fluoro (F), chloro (Cl), bromo (Br), or iodo (I).

The term “oxo” refers to a divalent doubly bonded oxygen atom (i.e., “═O”). As used herein, oxo groups are attached to carbon atoms to form carbonyls.

The term “alkoxy” refers to an —O-alkyl radical (e.g., —OCH₃).

The term “hydroxyalkyl” refers to an alkyl, in which one or more hydrogen atoms is/are replaced with hydroxyl.

The term “haloalkyl” refers to an alkyl, in which one or more hydrogen atoms is/are replaced with an independently selected halogen.

The term “fluoroalkyl” refers to an alkyl, in which one or more hydrogen atoms is/are replaced with a fluorine. The term “aryl” refers to a 6-20 membered all carbon ring system wherein at least one ring in the system is aromatic (e.g., 6-carbon monocyclic, 10-carbon bicyclic, or 14-carbon tricyclic aromatic ring system). Examples of aryl groups include phenyl, naphthyl, tetrahydronaphthyl, and the like.

The term “carbocyclyl” as used herein refers to cyclic saturated hydrocarbon groups having, e.g., 3 to 20 ring carbons, preferably 3 to 16 ring carbons, and more preferably 3 to 12 ring carbons or 3-10 ring carbons or 3-6 ring carbons. Examples of cycloalkyl groups include, without limitation, cyclopropyl, cyclobutyl, cyclopentyl, cyclohexyl, cycloheptyl, and cyclooctyl. Cycloalkyl may include multiple fused and/or bridged rings. Non-limiting examples of fused/bridged cycloalkyl includes: bicyclo[1.1.0]butane, bicyclo[2.1.0]pentane, bicyclo[1.1.1]pentane, bicyclo[3.1.0]hexane, bicyclo[2.1.1]hexane, bicyclo[3.2.0]heptane, bicyclo[4.1.0]heptane, bicyclo[2.2.1]heptane, bicyclo[3.1.1]heptane, bicyclo[4.2.0]octane, bicyclo[3.2.1]octane, bicyclo[2.2.2]octane, and the like. Cycloalkyl also includes spirocyclic rings (e.g., spirocyclic bicycle wherein two rings are connected through just one atom). Non-limiting examples of spirocyclic cycloalkyls include spiro[2.2]pentane, spiro[2.5]octane, spiro[3.5]nonane, spiro[3.5]nonane, spiro[3.5]nonane, spiro[4.4]nonane, spiro[2.6]nonane, spiro[4.5]decane, spiro[3.6]decane, spiro[5.5]undecane, and the like. The term “saturated” as used in this context means only single bonds present between constituent carbon atoms.

The term “heteroaryl”, as used herein, refers to a ring system having 5 to 20 ring atoms, such as 5, 6, 9, 10, or 14 ring atoms; wherein at least one ring in the system contains one or more heteroatoms independently selected from the group consisting of N, O, S, Si, and B, and at least one ring in the system is aromatic (but does not have to be a ring which contains a heteroatom, e.g. tetrahydroisoquinolinyl, e.g., tetrahydroquinolinyl). Heteroaryl groups can include monocyclic, bridged, fused, and spiro ring systems, so long as one ring in the system is aromatic. Examples of heteroaryl include thienyl, pyridinyl, furyl, oxazolyl, oxadiazolyl, pyrrolyl, imidazolyl, triazolyl, thiodiazolyl, pyrazolyl, isoxazolyl, thiadiazolyl, pyranyl, pyrazinyl, pyrimidinyl, pyridazinyl, triazinyl, thiazolyl benzothienyl, benzoxadiazolyl, benzofuranyl, benzimidazolyl, benzotriazolyl, cinnolinyl, indazolyl, indolyl, isoquinolinyl, isothiazolyl, naphthyridinyl, purinyl, thienopyridinyl, pyrido[2,3-d]pyrimidinyl, pyrrolo[2,3-b]pyridinyl, quinazolinyl, quinolinyl, thieno[2,3-c]pyridinyl, pyrazolo[3,4-b]pyridinyl, pyrazolo[3,4-c]pyridinyl, pyrazolo[4,3-c]pyridine, pyrazolo[4,3-b]pyridinyl, tetrazolyl, chromane, 2,3-dihydrobenzo[b][1,4]dioxine, benzo[d][1,3]dioxole, 2,3-dihydrobenzofuran, tetrahydroquinoline, 2,3-dihydrobenzo[b][1,4]oxathiine, isoindoline, and others. In some embodiments, the heteroaryl is selected from thienyl, pyridinyl, furyl, pyrazolyl, imidazolyl, isoindolinyl, pyranyl, pyrazinyl, and pyrimidinyl. For purposes of clarification, heteroaryl also includes aromatic lactams, aromatic cyclic ureas, or vinylogous analogs thereof, in which each ring nitrogen adjacent to a carbonyl is tertiary (i.e., all three valences are occupied by non-hydrogen substituents), such as one or more of pyridine, wherein each ring nitrogen adjacent to a carbonyl is tertiary (i.e., the oxo group (i.e., “═O”) herein is a constituent part of the heteroaryl ring).

The term “heterocyclyl” refers to a saturated or partially unsaturated ring systems with 3-16 ring atoms (e.g., 3-8 membered monocyclic, 5-12 membered bicyclic, or 10-14 membered tricyclic ring system) having at least one heteroatom selected from O, N, S, Si, and B, wherein one or more ring atoms may be substituted by 1-3 oxo (forming, e.g., a lactam) and one or more N or S atoms may be substituted by 1-2 oxido (forming, e.g., an N-oxide, an S-oxide, or an S,S-dioxide), valence permitting. Heterocyclyl groups include monocyclic, bridged, fused, and spiro ring systems.

Examples of heterocyclyl groups include piperazinyl, pyrrolidinyl, dioxanyl, morpholinyl, tetrahydrofuranyl, tetrahydropyridyl, dihydropyrazinyl, dihydropyridyl, dihydropyrrolyl, dihydrofuranyl, dihydrothiophenyl, and the like. Heterocyclyl may include multiple fused and bridged rings. Non-limiting examples of fused/bridged heteorocyclyl includes: 2-azabicyclo[1.1.0]butane, 2-azabicyclo[2.1.0]pentane, 2-azabicyclo[1.1.1]pentane, 3-azabicyclo[3.1.0]hexane, 5-azabicyclo[2.1.1]hexane, 3-azabicyclo[3.2.0]heptane, octahydrocyclopenta[c]pyrrole, 3-azabicyclo[4.1.0]heptane, 7-azabicyclo[2.2.1]heptane, 6-azabicyclo[3.1.1]heptane, 7-azabicyclo[4.2.0]octane, 2-azabicyclo[2.2.2]octane, 3-azabicyclo[3.2.1]octane, 2-oxabicyclo[1.1.0]butane, 2-oxabicyclo[2.1.0]pentane, 2-oxabicyclo[1.1.1]pentane, 3-oxabicyclo[3.1.0]hexane, 5-oxabicyclo[2.1.1]hexane, 3-oxabicyclo[3.2.0]heptane, 3-oxabicyclo[4.1.0]heptane, 7-oxabicyclo[2.2.1]heptane, 6-oxabicyclo[3.1.1]heptane, 7-oxabicyclo[4.2.0]octane, 2-oxabicyclo[2.2.2]octane, 3-oxabicyclo[3.2.1]octane, and the like. Heterocyclyl also includes spirocyclic rings (e.g., spirocyclic bicycle wherein two rings are connected through just one atom). Non-limiting examples of spirocyclic heterocyclyls include 2-azaspiro[2.2]pentane, 4-azaspiro[2.5]octane, 1-azaspiro[3.5]nonane, 2-azaspiro[3.5]nonane, 7-azaspiro[3.5]nonane, 2-azaspiro[4.4]nonane, 6-azaspiro[2.6]nonane, 1,7-diazaspiro[4.5]decane, 7-azaspiro[4.5]decane 2,5-diazaspiro[3.6]decane, 3-azaspiro[5.5]undecane, 2-oxaspiro[2.2]pentane, 4-oxaspiro[2.5]octane, 1-oxaspiro[3.5]nonane, 2-oxaspiro[3.5]nonane, 7-oxaspiro[3.5]nonane, 2-oxaspiro[4.4]nonane, 6-oxaspiro[2.6]nonane, 1,7-dioxaspiro[4.5]decane, 2,5-dioxaspiro[3.6]decane, 1-oxaspiro[5.5]undecane, 3-oxaspiro[5.5]undecane, 3-oxa-9-azaspiro[5.5]undecane and the like.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF THE DRAWINGS

Non-limiting embodiments of the present disclosure will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure. In the figures:

FIG. 1 is a graph of the cycle number versus the capacity retention of a battery of the disclosure during an asymmetric cycling test.

FIG. 2 is a graph of the cycle number versus the capacity retention of various batteries of the disclosure.

FIG. 3 is a graph of the cycle numbers versus the capacity retention of various batteries of the disclosure during a charge rate test at various charge current densities.

### DETAILED DESCRIPTION

The present disclosure generally relates to electrolyte compositions suitable for various electrochemical devices. In some embodiments, the electrolyte compositions include an electrolyte salt, a polymer, and a solvent. In other embodiments, the electrolyte compositions do not include a polymer. The solvent can include a non-fluorinated ether or a non-fluorinated ether and a fluorinated ether.

The electrolyte compositions of the disclosure include one or more non-limiting advantageous properties as follows. The electrolyte compositions of the disclosure can be stable (e.g., passing safety testing such as the safety tests described in the examples below) when comprised in an electrochemical device (e.g., a battery) that includes a lithium metal anode. The electrolyte compositions of the disclosure when comprised in an electrochemical device can have improved wetting capabilities (e.g., wetting speed, contact angles, or the like). The electrolyte compositions of the disclosure when comprised in an electrochemical device (e.g., a battery) can have a capacity retention of at least 70% at low temperatures (e.g., 0° C., −10° C., or −20° C.). The electrolyte compositions of the disclosure when comprised in an electrochemical device (e.g., a battery) can be thermally stable as none of the components of the electrolyte composition have a boiling point of less than 100° C. The electrolyte compositions of the disclosure may be used to achieve safer, longer-life lithium batteries. The electrolyte compositions may exhibit better ionic conductivity. These properties may benefit charging/discharging rate performances. In some embodiments, the electrolyte composition further comprises a polymer.

In some embodiments, the electrolyte compositions of the disclosure include a solvent, wherein the solvent is a non-fluorinated ether. In some embodiments, the non-fluorinated ether is a compound of Formula (I): R^{1a}—O—R^{2a} (I), wherein: R^{1a} is C₁-C₁₀ alkyl; R^{2a} is —(CH₂)ₙ—O—(C₁-C₁₀ alkyl) or C₁-C₁₀ alkyl; or R^{1a} and R^{2a}, together with the oxygen atom to which they are attached form a 4-7 membered heterocyclyl; and n is an integer and is 1 or 2.

In some embodiments, R^{1a} is C₁-C₆ alkyl. In some embodiments, R^{1a} is methyl, ethyl, or propyl.

In some embodiments, R^{2a} is C₁-C₆ alkyl. In some embodiments, R^{2a} is methyl, ethyl, or propyl.

In some embodiments, R^{2a} is —(CH₂)ₙ—O—(C₁-C₁₀ alkyl). In some embodiments, R^{2a} is —(CH₂)ₙ—O—(C₁-C₆ alkyl). In some embodiments, R^{2a} is —(CH₂)ₙ—O—(C₁-C₃ alkyl). In some embodiments, R^{2a} is —(CH₂)ₙ—O—(C₁ alkyl), —(CH₂)ₙ—O—(C₂ alkyl), or —(CH₂)ₙ—O—(C₃ alkyl).

In some embodiments, R^{1a} and R^{2a}, together with the oxygen atom to which they are attached form a 4-7 membered heterocyclyl. In some embodiments, R^{1a} and R^{2a}, together with the oxygen atom to which they are attached form a 4-7 membered heterocyclyl, wherein the heterocyclyl includes one or two oxygen heteroatoms. In some embodiments, n is 1. In some embodiments, n is 2.

In some embodiments, the non-fluorinated ether can comprise 2-ethoxyethanol, dimethoxy methane, dimethoxy ethane, 1,2-diethoxyethane, 1,1-diethoxyethane, 1,1-dipropoxy-ethane, 1,2-dipropoxy-ethane, diethylene glycol, 2-(2-ethoxyethoxy)ethanol, diethylene glycol dimethyl ether, diethylene glycol diethyl ether, diethylene glycol dibutyl ether, triethylene glycol, tri(ethylene glycol) monomethyl ether, tri(ethylene glycol) monoethyl ether, tri(ethylene glycol) monobutyl ether, triethylene glycol dimethyl ether, triethylene glycol diethyl ether, diethylene glycol dibutyl ether, tetraethylene glycol, tetra(ethylene glycol) monomethyl ether, tetra(ethylene glycol) monoethyl ether, tetra(ethylene glycol) monobutyl ether, tetraethylene glycol dimethyl ether, tetraethylene glycol diethyl ether, tetraethylene glycol dibutyl ether, or the like.

For example, the non-fluorinated ether can comprise one or more of 1,2-dimethoxyethane, 1,2-diethoxyethane, 1,2-dibutoxyethane, diethyl ether, dibutylether, di-tert-butyl ether, tert-butyl ethyl ether, tert-butyl methyl ether, 1,3-dioxolane, 1,4-dioxane, di(propylene glycol) methyl ether. In some embodiments, the non-fluorinated ether comprises 1,2-diethoxyethane.

In some embodiments, the solvent is substantially free of 1,2-dimethoxyethane. As used herein, the term “substantially free of” an ingredient(s) as provided throughout the disclosure is intended to mean that the composition or device contain less than about 0.1 wt % (percent by weight of the total weight of the composition or device(s)), or insignificant or negligible amounts of said ingredient(s) unless specifically indicated otherwise. In some embodiments, the compositions or devices of the present disclosure are substantially free of 1,2-dimethoxyethane, meaning that the compositions or devices contains less than about 0.1 wt % 1,2-dimethoxyethane.

In some embodiments, the electrolyte composition disclosed herein includes a solvent, wherein the solvent comprises a fluorinated ether. In some embodiments, the fluorinated ether is a compound of Formula (II):

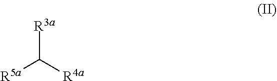

wherein R^{3a} is H, C₁-C₁₀ alkyl, C₁-C₁₀ fluoroalkyl, —O—(C₁-C₁₀ alkyl) or —O—(C₁-C₁₀ fluoroalkyl); R^{4a} and R^{5a} each independently are C₁-C₁₀ alkyl, C₁-C₁₀ fluoroalkyl, —O—(C₁-C₁₀ alkyl) or —O—(C₁-C₁₀ fluoroalkyl); and wherein at least one of R^{3a}, R^{4a}, and R^{5a} is —O—(C₁-C₁₀ alkyl) or —O—(C₁-C₁₀ fluoroalkyl), and at least one of R^{3a}, R^{4a}, and R^{5a} comprises a C₁-C₁₀ fluoroalkyl.

In some embodiments, R^{3a} is H. In some embodiments, R^{3a} is C₁-C₁₀ alkyl. In some embodiments, R^{3a} is C₁-C₆ alkyl. In some embodiments, R^{3a} is methyl, ethyl, or propyl.

In some embodiments, R^{3a} is —O—(C₁-C₁₀ alkyl). In some embodiments, R^{3a} is —O—(C₁-C₆ alkyl). In some embodiments, R^{3a} is —O—(C₁-C₃ alkyl).

In some embodiments, R^{3a} is —O—(C₁-C₁₀ fluoroalkyl). In some embodiments, R^{3a} is —O—(C₁-C₆ fluoroalkyl). In some embodiments, R^{3a} is —O—(C₁-C₃ fluoroalkyl). In some embodiments, R^{3a} is —O—(CF₃) or —O—(CHF₂).

In some embodiments, R^{4a} is C₁-C₁₀ alkyl. In some embodiments, R^{4a} is C₁-C₆ alkyl. In some embodiments, R^{4a} is methyl, ethyl, or propyl.

In some embodiments, R^{4a} is C₁-C₁₀ fluoroalkyl. In some embodiments, R^{4a} is C₁-C₆ fluoroalkyl. In some embodiments, R^{4a} is —CF₃, —CH₂—CHF₂ or —CF₂—CH₃.

In some embodiments, R^{4a} is —O—(C₁-C₁₀ alkyl). In some embodiments, R^{4a} is —O—(C₁-C₆ alkyl). In some embodiments, R^{4a} is —O—(C₁-C₃ alkyl).

In some embodiments, R^{4a} is —O—(C₁-C₁₀ fluoroalkyl). In some embodiments, R^{4a} is —O—(C₁-C₆ fluoroalkyl). In some embodiments, R^{4a} is —O—(C₁-C₃ fluoroalkyl).

In some embodiments, R^{5a} is C₁-C₁₀ alkyl. In some embodiments, R^{5a} is C₁-C₆ alkyl. In some embodiments, R^{5a} is methyl, ethyl, or propyl.

In some embodiments, R^{5a} is C₁-C₁₀ fluoroalkyl. In some embodiments, R^{5a} is C₁-C₆ fluoroalkyl. In some embodiments, R^{5a} is —CF₃, —CH₂—CHF₂, or —CF₂—CH₃.

In some embodiments, R^{5a} is —O—(C₁-C₁₀ alkyl). In some embodiments, R^{5a} is —O—(C₁-C₆ alkyl).

In some embodiments, R^{5a} is —O—(C₁-C₃ alkyl).

In some embodiments, R^{5a} is —O—(C₁-C₁₀ fluoroalkyl). In some embodiments, R^{5a} is —O—(C₁-C₆ fluoroalkyl). In some embodiments, R^{5a} is —O—(C₁-C₃ fluoroalkyl).

For example, the fluorinated ether comprises one or more of bis(2,2,2-trifluoroethoxy)methane (BTFM), 1,1,1,3,3,3-hexafluoro-2-(1,1,1,3,3,3-hexafluoropropan-2-yloxymethoxy)propane, bis(3,3,3-trifluoropropoxy)methane, 1,1,1-trifluoro-3-[(2,2,2-trifluoroethoxy)methoxy]propane, bis(2,2,3,3,3-pentafluoropropoxy)methane, and 1,1,1,2,2-pentafluoro-3-((2,2,2-trifluoroethoxy)methoxy)propane, 1,1,2,2-tetrafluoroethyl-2,2,3,3-tetrafluoropropyl ether (TTE), 1H,1H,5H-octafluoropentyl-1,1,2,2-tetrafluoroethyl ether (OTE), Bis(2,2,2-trifluoroethyl) ether, 1H,1H,2′H-Perfluorodipropyl ether, 2,2,2-Trifluoroethyl 1,1,2,2-tetrafluoroethyl ether, 1,2-(1,1,2,2-Tetrafluoroethoxy)ethane (TFEE), and tris(2,2,2-trifluoroethyl)orthoformate (TFEO). In some embodiments, the fluorinated ether is BTFM.

In some embodiments, in Formula (II) R^{3a} is H, —O—(C₁-C₁₀ alkyl) or —O—(C₁-C₁₀ fluoroalkyl) and R^{4a} and R^{5a} each independently are —O—(C₁-C₁₀ alkyl) or —O—(C₁-C₁₀ fluoroalkyl). For example, the fluorinated ether can comprise bis(2,2,2-trifluoroethoxy)methane (BTFM) or tris(2,2,2-trifluoroethyl)orthoformate (TFEO).

The solvent can comprise the non-fluorinated ether in an amount in a range from 0.1 wt % to about 100 wt %. For example, the solvent comprises the non-fluorinated ether in an amount in a range from 0.1 wt % to about 99 wt %, from about 10 wt % to about 90 wt %, from about 20 wt % to about 80 wt %, from about 25 wt % to about 70 wt %, from about 25 wt % to about 45 wt %, or from about 50 wt % to about 80 wt %. In some embodiments, the solvent comprises the non-fluorinated ether in an amount in a range from about 25 wt % to about 45 wt % or from about 30 wt % to about 40 wt %.

The solvent can comprise the fluorinated ether in an amount in a range from 0.1 wt % to about 99 wt %. For example, the solvent comprises the fluorinated ether in an amount in a range from 0.1 wt % to about 99 wt %, from about 10 wt % to about 90 wt %, from about 20 wt % to about 80 wt %, from about 25 wt % to about 75 wt %, or from about 55 wt % to about 75 wt %. In some embodiments, the solvent comprises the fluorinated ether in an amount in a range from about 55 wt % to about 75 wt % or from about 60 wt % to about 70 wt %.

In some embodiments, the non-fluorinated ether and the fluorinated ether are present in a weight ratio of 1:20 to 20:1, 1:10 to 10:1, 1:5 to 10:1, 1:3 to 8:1, or 1:1 to 3:1. In some embodiments, the non-fluorinated ether and the fluorinated ether are present in a weight ratio in a range from 1:3 to 8:1 or from 1:1 to 3:1.

In some embodiments, the solvent has a boiling point of at least 100° C. at 1 atm. In some embodiments, the solvent has a boiling point of at least 110° C. at 1 atm, at least 120° C. at 1 atm, at least 130° C. at 1 atm, or at least 140° C. at 1 atm. In some embodiments, the fluorinated ether and/or the non-fluorinated ether has a boiling point of at least 100° C. at 1 atm. In some embodiments, the solvent has a boiling point of at least 110° C. at 1 atm, at least 120° C. at 1 atm, at least 130° C. at 1 atm, or at least 140° C. at 1 atm.

The solvent can be present in the electrolyte composition in an amount of at least 15 wt %, based on the total weight of the electrolyte composition. For example, the solvent is present in the electrolyte composition in an amount of at least 15 wt %, at least 20 wt %, at least 30 wt %, at least 40 wt %, at least 50 wt %, at least 60 wt %, at least 70 wt %, at least 80 wt %, at least 85 wt %, at least about 90 wt %, at least about 95 wt %, or at least about 98 wt %. For another example, the solvent is present in the electrolyte composition in a range from about 15 wt % to about 95 wt %, from about 25 wt % to 95 wt %, from about 50 wt % to 95 wt %, from about 75 wt % to about 90 wt %, from about 85 wt % to about 99.5 wt %, from about 85 wt % to about 99 wt %, from about 90 wt % to about 99 wt %, from about 30 wt % to about 60 wt %, or from about 40 wt % to about 55 wt %, based on the total weight of the electrolyte composition. In some embodiments, the solvent is present in the electrolyte composition in an amount in a range from 40 wt % to about 55%, or from about 75 wt % to about 90 wt %, based on the total weight of the electrolyte composition.

The electrolyte salt can be present in the electrolyte composition in an amount of about 5 wt % to about 85 wt %, based on the total weight of the electrolyte composition. For example, the electrolyte salt can be present in the electrolyte composition in an amount of about 5 wt % to about 75 wt %, or about 15 wt % to about 75 wt %, or about 25 wt % to about 75 wt %, or about 30 wt % to about 70 wt %, or about 40 wt % to about 60 wt %, or about 15 wt % to about 50 wt %, or about 10 wt % to about 30 wt %, based on the total weight of the electrolyte composition. In some embodiments, the electrolyte salt can be present in the electrolyte composition in an amount of about 40 wt % to about 60 wt %, based on the total weight of the electrolyte composition. In some embodiments, the electrolyte salt is present in the electrolyte composition in an amount of about 10 wt % to about 30 wt %, based on the total weight of the electrolyte composition.

The polymer can be present in the lectrolyte composition of the disclosure in an amount of about 0.1 wt % to about 15 wt %, based on the total weight of the electrolyte composition. For example, the polymer is present in the electrolyte composition of the disclosure in an amount of about 0.1 wt % to about 10 wt % about 0.5 wt % to about 5 wt %, or about 0.5 wt % to about 2.5 wt %, based on the total weight of the electrolyte composition.

In some embodiments, the electrolyte compositions of the disclosure comprise the solvent in an amount of about 15 wt % to about 95 wt %; the electrolyte salt in an amount of about 5 wt % to about 85 wt %; and the polymer in an amount of about 0.1 wt % to about 15 wt %, based on the total weight of the electrolyte composition. In some embodiments, the electrolyte compositions of the disclosure comprise the solvent in an amount of about 40 wt % to about 60 wt %; the electrolyte salt in an amount of about 40 wt % to about 60 wt %; and the polymer in an amount of about 0.5 wt % to about 2.5 wt %, based on the total weight of the electrolyte composition. In some embodiments, the electrolyte compositions of the disclosure comprise the solvent in an amount of about 70 wt % to about 90 wt %; the electrolyte salt in an amount of about 10 wt % to about 30 wt %; and the polymer in an amount of about 0.5 wt % to about 2.5 wt %, based on the total weight of the electrolyte composition.

Certain aspects include a polymer, a solvent, and an electrolyte salt. In some cases, the electrolyte composition may include a polymer that is crosslinked and has a heterogeneous polymer network obtained from a crosslinking reaction of a composition comprising one or more crosslinkers. In some embodiments, the polymer is synthesized from one or more crosslinkers, wherein at least one crosslinker has three or more polymerizable or crosslinkable terminals. In some embodiments, at least one of the one or more crosslinkers has three or more polymerizable or crosslinkable terminals.

In certain embodiments, the crosslinker with three or more polymerizable or crosslinkable terminals has a formula as follows:

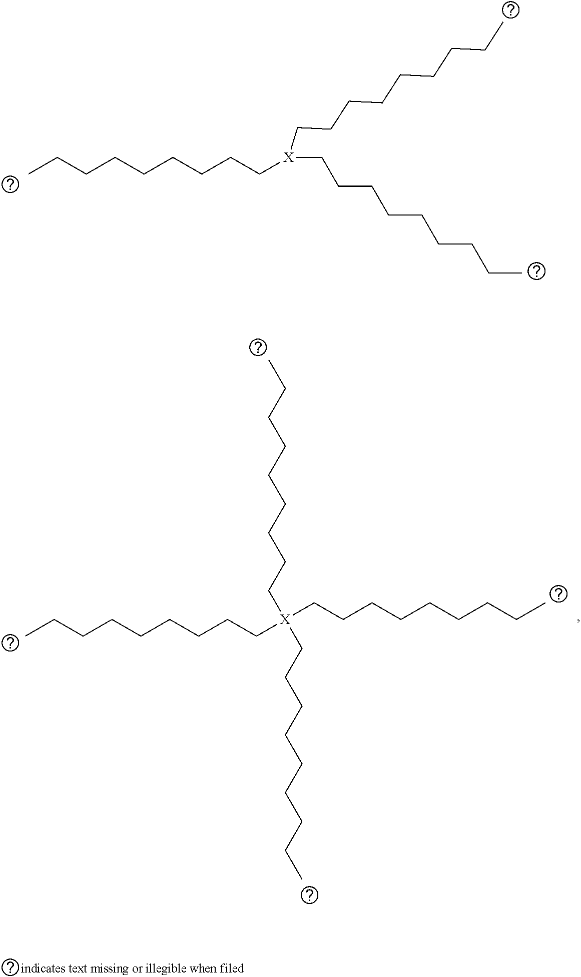

wherein X is C, Si, N, P, B, or a cyclic ring, R1, R2, and R3 are polymerizable or crosslinkable terminals covalently connected to X directly or via a spacer chain or group. R1, R2, R3 and their spacer chains or groups may be same or different from each other.

In certain embodiments, the three or more polymerizable or crosslinkable terminals (R1, R2, R3 and R4) are independently selected from the group consisting of C₂₋₂₀ alkenyl, C₂₋₂₀ alkynyl, epoxy, amino, hydroxyl, carboxylic acid, or any substituted form thereof.

In certain embodiments, the crosslinker with three or more polymerizable or crosslinkable terminals is a tri-acrylate, tetra-acrylate, modified tri-acrylate, modified tetra-acrylate, silane, siloxane or triazinane-trione (triazine-trione).

In certain embodiments, the crosslinker with three or more terminals has a formula selected from the group consisting of:

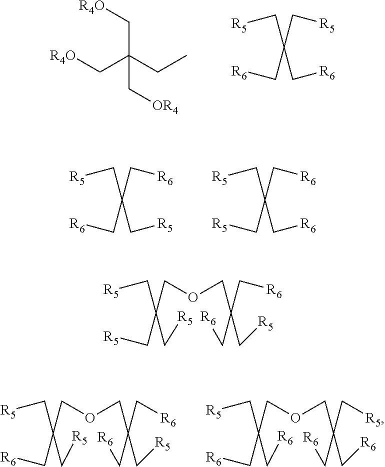

wherein R₄ and R₅ are independently selected from the group consisting of:

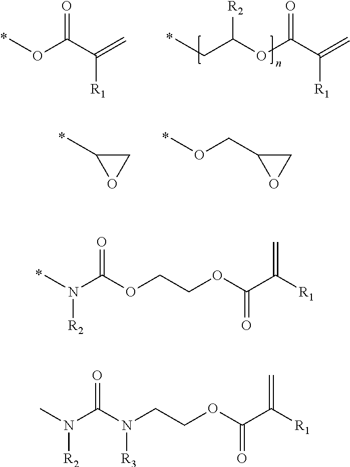

wherein R₁, R₂, R₃, R₆ are each independently selected from the group consisting of hydrogen, methyl, ethyl, phenyl, methyl phenyl, benzyl, acryl, epoxy ethyl, isocyanate, cyclic carbonate, lactone, lactam, and vinyl, wherein n is an integer between 0 and 50,000 and * indicates a point of attachment.

In certain embodiments, the crosslinker has a formula of:

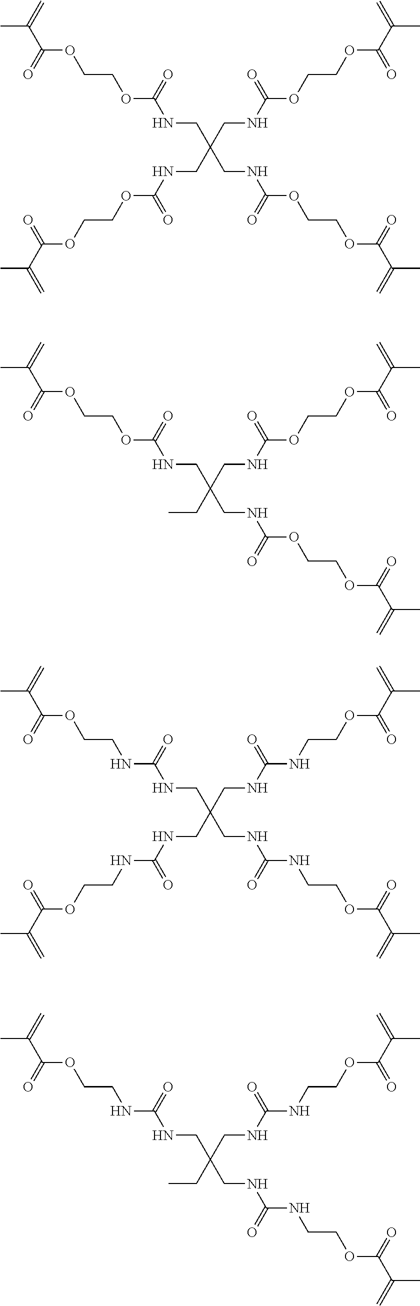

In certain embodiments, modified tri-acrylates and tetra-acrylates include tri-acrylates and tetra-acrylates with substituted groups such as —CN, —SO₂H, —CO₂H, —CO₂—, F, Cl, Br, or I.

In certain embodiments, the crosslinker with three or more terminals is a silane or siloxane.

In some embodiments, one or more of the crosslinkers or the spacer chains or groups contain a structure including, but not limited to, —O—, —NR^{c}—, —S—, —C(═O)—, —C(═O)O—, —C(═O)NR^{c}—, —C(═O)S—, —OC(═O)O—, —NR—C(═O)O—, —NR—C(═O)NR—, —S(═O)—, —S(═O)₂—, —OS(═O)₂—, —OS(═O)₂O—, —NR^{c}S(═O)₂—, —NR^{c}S(═O)₂NR^{c}—, —OS(═O)₂NR^{c}—, C₁₋₆ alkylenyl, C₂₋₆ alkenylenyl, C₂₋₆ alkynylenyl, C₆₋₁₄ arylenyl, 5- to 14-membered heteroarylenyl, C₃₋₁₀ carbocyclenyl, or 3- to 10-membered heterocyclenyl, wherein the alkylenyl, alkenylenyl, alkynylenyl, arylenyl, heteroarylenyl, carbocyclenyl, or heterocyclenyl is optionally substituted with halogen, —CN, —NO₂, C₁₋₆ alkyl, C₁₋₆ haloalkyl, C₁₆ hydroxyalkyl, C₁₆ aminoalkyl, C₂₋₆ alkenyl, C₂₋₆ alkynyl, C₆₋₁₄ aryl, 5- to 14-membered heteroaryl, C₃₋₁₀ carbocyclyl, 3- to 10-membered heterocyclyl, —SR^{b}, —S(═O)R^{a}, —S(═O)₂R^{a}, —S(═O)₂OR^{b}, —S(═O)₂NR^{c}R^{d}, —NR^{c}R^{d}, —NR^{c}S(═O)₂R^{a}, —NR^{c}S(═O)₂R^{a}, —NRCS(═O)₂OR^{b}, —NR^{c}S(═O)₂NR^{c}R^{d}, —NR^{b}C(═O)NR^{c}R^{d}, —NR^{b}C(═O)R^{a}, —NR^{b}C(═O)OR^{b}, —OR^{b}, —OS(═O)₂R^{a}, —OS(═O)₂OR^{b}, —OS(═O)₂NR^{c}R^{d}, —OC(═O)R^{a}, —OC(═O)OR^{b}, —OC(═O)NR^{c}R^{d}, —C(═O)R^{a}, —C(═O)OR^{b}, or —C(═O)NR^{c}R^{d}; wherein R^{a}, R^{b}, R^{c}, and R^{d} are independently C₁₋₆ alkyl, C₁₋₆ haloalkyl, C₁₆ hydroxyalkyl, C₁₆ aminoalkyl, C₂₋₆ alkenyl, C₂₋₆ alkynyl, C₃₋₁₀ carbocyclyl, 3- to 10-membered heterocyclyl, C₆₋₁₄ aryl, or 5- to 14-membered heteroaryl, wherein the alkyl, haloalkyl, hydroxyalkyl, aminoalkyl, alkenyl, alkynyl, carbocyclyl, heterocyclyl, aryl, and heteroaryl is optionally substituted with one or more oxo, halogen, —CN, —OH, —OMe, —NH₂, —C(═O)Me, —C(═O)OH, —C(═O)OMe, C₁₆ alkyl, or C₁₆ haloalkyl.

In some embodiments, R^{c} and R^{d}, together with the hetero atom (such as N, O, S, P), form a 3- to 10-membered heterocyclyl, wherein the heterocyclyl is optionally substituted with one or more oxo, halogen, —CN, —OH, —OMe, —NH₂, —C(═O)Me, —C(═O)OH, —C(═O)OMe, C₁₆ alkyl, or C₁₆ haloalkyl.

In certain embodiments, one of the crosslinkers or the spacer chains or groups comprise a structure of —XC(═O)CR³═C(R⁴)₂, wherein X is independently O or NR^{e}, R^{e} is independently H or C₁₋₆ alkyl, and each R³ and R⁴ is independently H or C₁₋₆ alkyl.

In certain embodiments, one of the crosslinkers comprises one or more functional groups including without limitation:

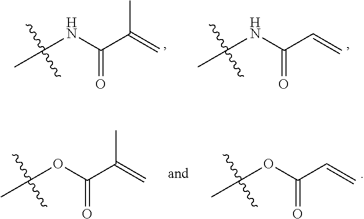

In certain embodiments, the crosslinker with one or more functional groups includes without limitation:

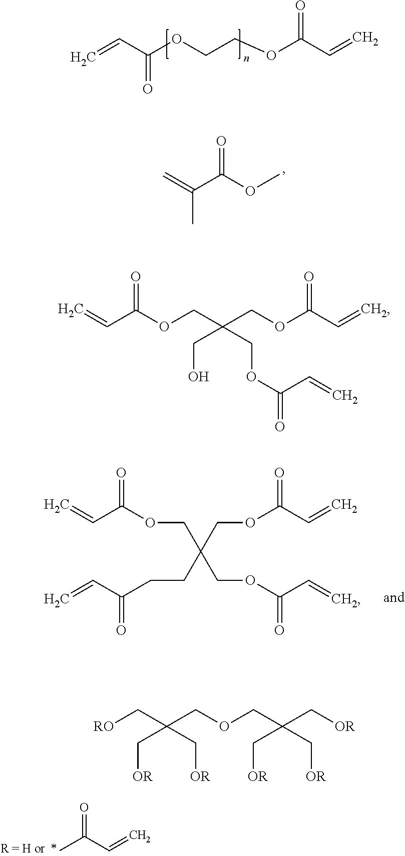

In some embodiments, the crosslinker with one or more functional groups is a monomer for ring opening polymerization and has a formular as follows:

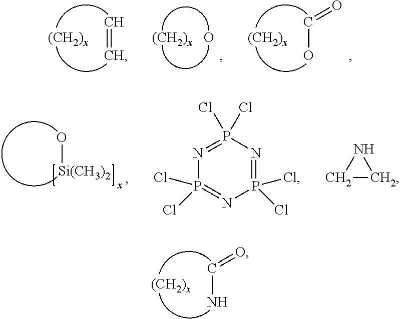

and any substituted form thereof, wherein x is an integer ranging from 1 to 1000.

In some embodiments, the monomer for ring opening polymerization includes:

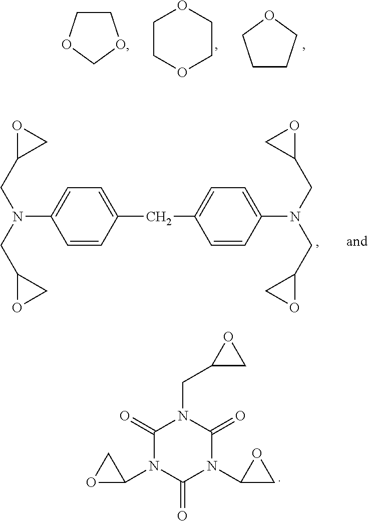

In some embodiments, the monomer for ring opening polymerization comprises an unsubstituted or substituted oxirane ring, oxetane ring, furan ring, aziridine ring, and azetidine ring.

In addition, certain embodiments are directed to compositions for use with polymer solid electrolytes, batteries, or other electrochemical devices including same, and methods for producing same. In some cases, the incorporation of vinyl and/or allyl functional groups with UV crosslinking or thermal crosslinking can be used to improve various electrochemical performance, especially when the crosslinker has polymerizable or crosslinkable terminals, such as vinyl and allyl, in at least three directions of the chemical structure of the crosslinker (i.e. the crosslinker has three crosslinkable terminals), the electrochemical performance can be improved more obviously.

In one aspect, the present disclosure is generally directed to an electrochemical cell, such as a battery, including a polymer electrolyte composition as disclosed herein. In certain embodiments, the battery is an LIB, such as a lithium-ion solid-state battery. The electrochemical cell may include an anode, a cathode, and/or a separator. Many of these are available commercially. In some embodiments, the polymer electrolyte composition of the disclosure may be used as the electrolyte of the electrochemical cell, alone and/or in combination with other electrolyte materials.

In some embodiments, polymerizable and crosslinkable terminals (alternatively groups) include without limitation C₂₋₂₀ alkenyl, C₂₋₂₀ alkynyl, epoxy, amino, hydroxyl, carboxylic acid, or any substituted form thereof. In certain embodiment, they are vinyl and/or allyl.

In addition, in one set of embodiments, the terminals or groups such as vinyl and/or allyl may be crosslinked together. For example, such functional groups may be crosslinked using UV light, at an elevated temperature (e.g., between 20° C. and 100° C.), in the presence of an initiator, or other methods including those described herein. In some cases, the incorporation of three crosslinkable terminals leads to a disorganized or disordered network, resulting in improved electrochemical performances, or the like, such as relatively high ionic conductivities, decomposition voltages.

The electrolyte composition of the disclosure can include an electrolyte salt. The electrolyte salt may be, for example, a lithium salt, or other salts such as sodium, potassium, magnesium, calcium salts, and the like.

In some embodiments, the electrolyte salt comprises a lithium salt. In some embodiments, the electrolyte salt includes one or more of lithium perchlorate (LiClO₄), lithium nitrate (LiNO₃), lithium hexafluorophosphate (LiPF₆), lithium borofluoride (LiBF₄), lithium hexafluoroarsenide (LiAsF₆), lithium trifluorometasulfonate (LiCF₃SO₃), lithium bisperfluoro-ethysulfonylimide (LiBETI), lithium bis(fluorosulfonyl)imide (LiFSI), lithium bis(trifluoromethanesulfonyl)imide (LiN(CF₃SO₂)₂, LiTFSI), lithium bis(oxalato)borate (LiBOB), lithium difluoro(oxalato)borate (LiBF₂C₂O₄, LiDFOB), lithium fluoroalkyl-phosphates (Li[PFₓ(C_{y}F_{2y+1-z}H_{z})₆₋ₓ]) (1≤x≤5, 1≤y≤8, and 0≤z≤2y−1), lithium fluorophosphate (Li₂PO₃F), lithium difluorophosphate (LiDFP), lithium difluoro(bisoxalato)phosphate (LiC₄PO₈F₂), and lithium tetrafluoro oxalato phosphate (LiC₂PO₄F₄), lithium tris(trifluoromethanesulfonyl)methide (LiC(CF₃SO₂)₃), LiF, LiCl, LiBr, LiI, Li₂SO₄, Li₃PO₄, Li₂CO₃, LiOH, lithium acetate, lithium trifluoromethyl acetate, and lithium oxalate. In some embodiments, the electrolyte salt comprises one or more of LiFSI and LiTFSI.

Provided herein is an electrochemical device comprising the electrolyte composition as described herein.

In some embodiments, the electrochemical device is anode-free or comprises an anode. In some embodiments, the electrochemical device comprises an anode.

In some embodiments, the anode is a carbon anode, Li anode, Si anode, Alloy anode, Li₄Ti₅O₁₂, or made from conversion anode materials. In some embodiments, the carbon anode comprises graphite, soft carbon, hard carbon, or combinations of thereof. In some embodiments, the Li anode comprises Li metal foil, Li metal on Cu, Ni, or stainless steel. In some embodiments, the Si anode comprises Si, Si/Carbon composite, SiOₓ (0≤x≤2), SiOₓ (0≤x≤2)/carbon composite or a combination thereof. In some embodiments, the alloy anode comprises Sn, SnO₂, Sb, Al, Mg, Bi, In, As, Zn, Ga, B, or a combination thereof. In some embodiments, the conversion anode materials comprise MₐX_{b}, M is Mn, Fe, Co, Ni, or Cu, X is O, S, Se, F, N, or P, a and b are respectively 1 to 4. In some embodiments, the anode is Li metal foil or Li metal on Cu, Ni, or stainless steel.

In some embodiments, the electrochemical device comprises a cathode. In some embodiments, the cathode comprises an electroactive material including one or more of lithium nickel cobalt manganese oxide, lithium nickel cobalt aluminum oxide, lithium titanate, metallic lithium, lithium metal oxide, lithium manganese oxide, lithium cobalt oxide, and lithium iron phosphate.

In some embodiments, the electrochemical device disclosed herein passes an overcharge test, wherein the electrochemical device is at 100% state-of-charge and is overcharged at 3 mA/cm² charge rate for 1 hour or when 8.5V is reached with a European Council for Automotive Research (EUCAR) hazard level of 4 or below. The EUCAR hazard levels can be found in Table 1. In some embodiments, the electrochemical device is an LIB and passes an overcharge test, wherein the electrochemical device is at 100% state-of-charge and is overcharged at a 3 mA/cm² charge rate for 1 hour or when 8.5V is reached with a EUCAR hazard level of 4 or below.

TABLE 1
European Council for Automotive Research Hazard Levels

| Hazard Level | Description | Classification Criteria |
|---|---|---|
| 0 | No effect | No effect. No loss of functionality |
| 1 | Passive protection | No defect; no leakage; no venting; no fire or flame; no |
| | activated | rupture; no explosion; no exothermic reaction or |
| | | thermal runaway. Cell irreversibly damaged. Repair is |
| | | needed |
| 2 | Defect/Damage | No leakage; no leakage; no venting; no fire or flame; |
| | | no rupture; no explosion; no exothermic reaction or |
| | | thermal runaway. Cell irreversibly damaged. Repair is |
| | | needed |
| 3 | Leakage, Δ mass <50% | No venting; no fire or flame; no rupture; no explosion; |
| | | weight loss ≥50% of electrolyte weight (electrolyte = |
| | | salt + solvent) |
| 4 | Venting, Δ mass <50% | No fire or flame; no rupture; no explosion; weight |
| | | loss ≥50% of electrolyte weight (electrolyte = salt + |
| | | solvent) |
| 5 | Fire or Flame | No rupture; no explosion (e.g., no flying parts) |
| 6 | Rupture | No explosion; but flying parts of the active mass |
| 7 | Explosion | Explosion (e.g., disintegration of the cell) |

In some embodiments, the electrochemical device passes a hotbox test, wherein the electrochemical device is at 100% state-of-charge and is held at each of the following temperatures: 130° C., 140° C., 150° C., 160° C., 170° C., 180° C., and 190° C. for 10 minutes with a EUCAR hazard level of 4 or below. In some embodiments, the electrochemical device is an LIB and passes a hotbox test, wherein the electrochemical device is at 100% state-of-charge and is held at each of the following temperatures: 130° C., 140° C., 150° C., 160° C., 170° C., 180° C., and 190° C. for 10 minutes with a EUCAR hazard level of 4 or below. In some embodiments the LIB is a lithium-ion solid-state battery.

In some embodiments, the electrochemical device maintains a specific capacity of at least 160 mAh/g for at least 200 asymmetric cycles, or at least 220 asymmetric cycles, or at least 250 asymmetric cycles, wherein the charge current is 1 mA/cm² and the discharge current is 3 mA/cm². In some embodiments, the electrochemical device is an LIB and maintains a specific capacity of at least 160 mAh/g for at least 200 asymmetric cycles, or at least 220 asymmetric cycles, or at least 250 asymmetric cycles, wherein the charge current is 1 mA/cm² and the discharge current is 3 mA/cm².

In some embodiments, the electrochemical device is an LIB and maintains a specific capacity of at least 160 mAh/g for at least 220 asymmetric cycles, wherein the charge current is 1 mA/cm² and the discharge current is 3 mA/cm². In some embodiments, the electrochemical device is an LIB and maintains a specific capacity of at least 160 mAh/g for at least 250 asymmetric cycles, wherein the charge current is 1 mA/cm² and the discharge current is 3 mA/cm².

In some embodiments, the electrochemical device maintains a specific capacity of at least 140 mAh/g for at least 120 symmetric cycles, or at least 130 symmetric cycles, or at least 135 symmetric cycles, wherein the charge current and discharge current is 1 mA/cm². In some embodiments, the electrochemical device is an LIB and maintains a specific capacity of at least 140 mAh/g for at least 120 symmetric cycles, or at least 130 symmetric cycles, or at least 135 symmetric cycles, wherein the charge current and discharge current is 1 mA/cm². In some embodiments, the electrochemical device is an LIB and maintains a specific capacity of at least 140 mAh/g for at least 130 symmetric cycles, wherein the charge current and discharge current is 1 mA/cm². In some embodiments, the electrochemical device is an LIB and maintains a specific capacity of at least 140 mAh/g for at least 135 symmetric cycles, wherein the charge current and discharge current is 1 mA/cm².

In some embodiments, the electrochemical device has a charge current density of at least about 10 mA/cm², at least about 15 mA/cm², at least about 18 mA/cm², or about 10 mA/cm² to about 18 mA/cm². In some embodiments, the electrochemical device is an LIB and has a charge current density of at least about 10 mA/cm², at least about 15 mA/cm², at least about 18 mA/cm², or about 10 mA/cm² to about 18 mA/cm². In some embodiments, the electrochemical device is an LIB and has a charge current density of about 10 mA/cm² to about 18 mA/cm². In some embodiments, the electrochemical device is an LIB and has a charge current density of about 12 mA/cm² to about 18 mA/cm².

In some embodiments, the electrochemical device has a charge current density of at least about 6 mA/cm². For example, the electrochemical device has a charge current density of at least about 9 mAh/cm², at least about 10.5 mAh/cm², at least about 12 mAh/cm², at least about 13.5 mAh/cm², at least about 15 mAh/cm², or at least about 16.5 mAh/cm². In some embodiments, the electrochemical device is an LIB and has a charge current density of at least about 9 mAh/cm², at least about 10.5 mAh/cm², at least about 12 mAh/cm², at least about 13.5 mAh/cm², at least about 15 mAh/cm², or at least about 16.5 mAh/cm². In some embodiments, the electrochemical device has a charge current density of at least about 13.5 mAh/cm² or about 16.5 mAh/cm².

In some embodiments, the electrochemical device has a capacity retention of at least 50% (e.g., 50% to 100%) at a temperature in a range from 0° C. to −20° C. for at least 3 hours. For example, the electrochemical device is an LIB and has a capacity retention of at least 50%, at least 60%, at least 70%, or at least 80% at a temperature in a range from 0° C. to −20° C., or from −10° C. to −20° C. for at least 3 hours, at least 6 hours, or at least 12 hours. In some embodiments, the electrochemical device is an LIB and has a capacity retention of at least 80% at a temperature of −20° C. for at least 6 hours.

In some embodiments, the electrochemical device is an LIB and has a capacity retention of at least 80% at a temperature of −20° C. for at least 12 hours.

Also provided herein are electrochemical devices comprising an anode; a cathode; and a polymer electrolyte composition of the disclosure, wherein the polymer electrolyte composition of the disclosure comprises an electrolyte salt disclosed herein, a polymer disclosed herein, and a solvent comprising a non-fluorinated ether; wherein the electrochemical device has a capacity retention of at least 70% at a temperature in a range from −10° C. to −20° C. for at least 6 hours. In some embodiments, the electrochemical device is an LIB. In some embodiments, the solvent further comprises a fluorinated ether. In some embodiments, the electrochemical device has a capacity retention of at least 70% at a temperature in a range from −10° C. to −20° C. for at least 12 hours.

Also provided herein are electrochemical devices comprising an anode; a cathode; and a polymer electrolyte composition of the disclosure, wherein the polymer electrolyte composition of the disclosure comprises an electrolyte salt, a polymer and a solvent comprising a non-fluorinated ether; wherein the electrochemical device passes a hotbox test, wherein the electrochemical device is at 100% state-of-charge and is held at each of the following temperatures: 130° C., 140° C., 150° C., 160° C., 170° C., 180° C., and 190° C. for 10 minutes with a EUCAR hazard level of 4 or below. In some embodiments, the electrochemical device is an LIB. In some embodiments, the solvent further comprises a fluorinated ether. In some embodiments the LIB is a lithium-ion solid-state battery.

Also provided herein are electrochemical devices comprising an anode; a cathode; and a polymer electrolyte composition of the disclosure, wherein the polymer electrolyte composition of the disclosure comprises an electrolyte salt, a polymer, and a solvent comprising a non-fluorinated ether; wherein the electrochemical device passes an overcharge test, wherein the electrochemical device is at 100% state-of-charge and is overcharged at a 3 mA/cm² charge rate for 1 hour or when 8.5V is reached with a EUCAR hazard level of 4 or below. In some embodiments, the electrochemical device is an LIB. In some embodiments, the solvent further comprises a fluorinated ether.

Also provided herein are electrochemical devices comprising an anode; a cathode; and a polymer electrolyte composition of the disclosure, wherein the polymer electrolyte composition of the disclosure comprises an electrolyte salt, a polymer, and a solvent comprising a non-fluorinated ether; wherein the electrochemical cell has a charge current density in a range of about 10.5 mA/cm² to about 16.5 mA/cm². In some embodiments, the electrochemical device is an LIB. In some embodiments, the solvent further comprises a fluorinated ether. In some embodiments, the electrochemical cell has a charge current density in a range of about 12 mA/cm² to about 16.5 mA/cm². In some embodiments, the electrochemical cell has a charge current density of at least about 15 mA/cm². In some embodiments, the LIB is a lithium-ion solid-state battery.

In some embodiments, the polymer electrolyte composition of the disclosure may further include an additive. In some embodiments, the additive may provide improved processability, and/or controlled ionic conductivity and mechanical strength. For example, the additive may be a polymer, a small molecule (i.e., having a molecular weight of less than 1 kDa), a nitrile, cyclic carbonate, ionic liquids, or the like. Non-limiting examples of potentially suitable additives include ethylene carbonate, diethyl carbonate, dimethyl carbonate, ethyl methyl carbonate, propylene carbonate, fluoroethylene carbonate, vinylene carbonate, succinonitrile, succinonitrile, glutaronitrile, hexonitrile, malononitrile, dimethyl sulfoxide, prop-1-ene-1,3-sultone, sulfolane, ethyl vinyl sulfone, tetramethylene sulfone, vinyl sulfone, methyl vinyl sulfone, phenyl vinyl sulfone, N-propyl-N-methylpyrrolidinium bis(fluorosulfonyl)imide, 1-ethyl-3-methylimidazolium bis(fluorosulfonyl)imide, trimethyl phosphate, triethyl phosphate, poly(ethylene oxide), or the like. In some other cases, the additives may act as plasticizer.

In some embodiments, the additive can be present at a weight percentage of about 1 wt % to about 10 wt % or about 0.01 wt % to about 5 wt %, based on a total weight of the polymer electrolyte composition.

In some embodiments, the polymer electrolyte composition may further include an initiator. Specific non-limiting examples of initiators include photoinitiator, 2,2′-azobis(2-methylpropionitrile), benzoyl peroxide, cumene hydroperoxide, dicumyl peroxide, ter-butyl hydroperoxide, di-tert-butyl peroxide, 2,2′-azobis[2-(2-imidazoline-2-yl)propane] dihydrochloride, ammonium persulfate, anisoin, anthraquinone, benzophenone, benzoin methyl ether, 2-isopropylthioxanthone, 9,10-phenanthrenequinone, 3′-hydroxyacetophenone, 3,3′,4,4′-benzophenonetetreacarboxylic dianhydride, 2-benzoylbenzoic acid, (±)-camphorquinone, 2-ethylanthraquinone, 2-methylbenzophenone, 4-hydroxybenzophenone, 2-hydroxy-2-methylpropiophenone, benzoin isobutyl ether, 4,4′-bis(dimethylamino)benzophenone, 4,4′-dihydroxybenzophenone, 4-benzoyl 4′-methyldiphenyl sulfide, ferrocene, dibenzosuberenone, benzoin ethyl ether, benzil, methyl benzoylformate, 4-benzoylbenzoic acid, or others alike. In some cases, the initiator has a weight fraction (weight percentage) between 0.01 wt % and 5 wt %, or other suitable mole fractions to initiate crosslinking, based on a total weight of the polymer solid electrolyte. In some embodiments, the weight fraction is no more than 5.0 wt %, no more than 4.0 wt %, no more than 3.0 wt %, no more than 2.0 wt %, or no more than 1.0 wt %. In some embodiments, the weight fraction is no more than 1.0%, no more than 0.8 wt %, no more than 0.6 wt %, no more than 0.4 wt %, no more than 0.2 wt %, no more than 0.1 wt %, or no more than 0.05 wt %.

Certain aspects of the disclosure are generally directed to systems and methods for producing any of the polymer electrolyte compositions discussed herein. For example, a polymer may be produced by reacting various crosslinkers together.

In some cases, during the curing process, at least some of the crosslinkers may also crosslink, e.g., as discussed herein, which in some cases may improve various electrochemical performance. For example, exposure to UV light may facilitate the crosslinking process.

The present disclosure generally relates to a device with the polymer electrolyte compositions disclosed herein. The device may be a battery, an LIB or a lithium-ion solid-state battery. The battery may be configured for applications such as portable applications, transportation applications, stationary energy storage applications, and the like. Non-limiting examples of the ion-conducing batteries include lithium-ion conducting batteries, and the like. The device may also be a battery comprising one or more lithium ions electrochemical cells.

In various examples, a battery includes a polymer electrolyte composition of the present disclosure, an anode, and a cathode with an electroactive material.

In various examples, the anode includes carbon anode, Li anode, Si anode, Alloy anode, and/or conversion anode materials. The carbon anode can include graphite, soft carbon, hard carbon, or combinations thereof. The Li anode can include Li metal foil, Li metal on Cu (or on other current collectors, such as stainless steel, Ni). The Si anode can include Si, Si/Carbon composite anode, SiOₓ (0≤x≤2), SiOₓ((0≤x≤2)/carbon composite anode. The alloy anode can include Sn, SnO₂, Sb, Al, Mg, Bi, In, As, Zn, Ga, B. In various embodiments, a battery is anode free (only includes current collector).

The conversion anode materials can include MₐX_{b}, M is Mn, Fe, Co, Ni, Cu, and X is O, S, Se, F, N, P, etc. In addition, a and b are respectively 1 to 4.

In various embodiments, the anode materials include Li₄Ti₅O₁₂.

In various embodiments, the electroactive material includes lithium nickel cobalt manganese oxide, lithium nickel cobalt aluminum oxide, lithium titanate, metallic lithium, lithium metal oxide, lithium manganese oxide, lithium cobalt oxide, and lithium iron phosphate.

In some embodiments, the electrochemical device has a capacity retention of about 90% to about 100% after 250 cycles using a discharging current at a rate of 1 mA/cm²t 25° C. or has a capacity retention of at least 90% after 150 cycles using a discharging current at a rate of 1 mA/cm² at 25° C.

In some embodiments, the electrochemical device has a capacity retention of about 50% to about 99%, or about 70% to about 99% or about 80% to about 99%, or about 90% to about 99%, or at least 50%, at least 75%, at least 80%, when a discharging current rate of 0.33 C is being used at −20° C.

Some crosslinkers, electrolyte salts, additives and other materials as described in WO 2020096632 A1 and US application publication no. 20200144665 A1 and 20200144667 A1 are incorporated herein by reference in its entirety.

The following examples are intended to illustrate certain embodiments of the present disclosure, but do not exemplify the full scope of the disclosure.

The foregoing description and following examples detail certain specific embodiments of the disclosure and describe the best mode that the inventors contemplated. It will be appreciated, however, that no matter how detailed the foregoing may appear in text, the disclosure may be practiced in many ways, and the disclosure should be construed in accordance with the appended claims and equivalents thereof.

Although the disclosed teachings have been described with reference to various applications, methods, compounds, compositions, and materials, it will be appreciated that various changes and modifications to them may be made without departing from the teachings herein. The following examples are provided to better illustrate the disclosed teachings and are not intended to limit the scope of the teachings presented herein. While the present teachings have been described in terms of these exemplary embodiments, the skilled artisan will readily understand that numerous variations and modifications of these exemplary embodiments are possible without undue experimentation. All such variations and modifications are within the scope of the teachings of this disclosure.

### EXAMPLES

### Example 1A—Preparation of Electrochemical Devices

Preparation of a Pouch Cell with High Concentration of Ether Electrolyte (Battery A)

53 wt % LiFSI and 47 wt % 1,2-diethoxyethane were mixed to serve as base solution. 1.5 wt % pentaerythritol tetraacrylate and 0.1 wt % AIBN were added to the base solution. The base solution was thoroughly mixed for 30 minutes to form a homogeneous solution. The homogenous solution was injected into a pouch cell and was let sit for 48 hours at room temperature to allow the homogenous solution to be evenly distributed in the pouch cell. Then the pouch cell was left in the oven at 65° C. for 2 hours to enable thermal crosslinking. The pouch cell included LiNi_{0.8}Co_{0.1}Mn_{0.1}O₂ (NMC811) as cathode electrodes, Li laminated on Cu foil as anode electrodes, and polyolefin film as separator.

Preparation of a Pouch Cell with High Concentration of Ether-Fluorinated Ether Electrolyte (Battery B)

19 wt % LiFSI, 17 wt % 1,2-diethooxyethane, and 64 wt % bis(2,2,2-trifluoroethoxy)methane (BTFM) were mixed to serve as base solution. 1.5 wt % pentaerythritol tetraacrylate and 0.1 wt % AIBN were added to the base solution. The base solution was thoroughly mixed for 30 minutes to form a homogeneous solution. The homogenous solution was injected into a pouch cell and was let sit for 48 hours at room temperature to allow the homogenous solution to be evenly distributed in the pouch cell. Then the pouch cell was left in the oven at 65° C. for 2 hours to enable thermal crosslinking.

### Example 1B—Preparation of Electrochemical Devices

Preparation of a Pouch Cell with an Ether Electrolyte (Battery X)

40 wt % LiFSI and 60 wt % 1,2-dibutoxyethane are mixed to serve as base solution. 5 wt % poly(ethylene glycol) diacrylate (Mₙ=700) and 0.1 wt % 2,2′-Azobis(2-methylpropionitrile) (AIBN) are added to the base solution. The base solution is thoroughly mixed for 30 minutes to form a homogeneous solution. The homogenous solution is injected into a pouch cell and is let sit for 48 hours at room temperature to allow the homogenous solution to be evenly distributed in the pouch cell. Then the pouch cell is left in the oven at 65° C. for 2 hours to enable thermal crosslinking. The pouch cell included LiNi_{0.8}Co_{0.1}Mn_{0.1}O₂(NMC811) as cathode electrodes, Li laminated on Cu foil as anode electrodes, and polyolefin film as a separator.

Battery X is expected to perform similar to Battery A.

Preparation of a Pouch Cell with High Concentration of Ether Electrolyte (Battery Y)

25 wt % LiFSI, 25 wt % 1,2-dibutoxyethane, and 50 wt % 1,1,2,2-tetrafluoroethyl-2,2,3,3-tetrafluoropropyl ether (TTE) are mixed to serve as base solution. 5 wt % tris[2-(acryloyloxy)ethyl]isocyanurate and 0.1 wt % AIBN are added to the base solution. The base solution is thoroughly mixed for 30 minutes to form a homogeneous solution. The homogenous solution is injected into a pouch cell and is let sit for 48 hours at room temperature to allow the homogenous solution to be evenly distributed in the pouch cell. Then the pouch cell is left in the oven at 65° C. for 2 hours to enable thermal crosslinking. The pouch cell included LiNi_{0.8}Co_{0.1}Mn_{0.1}O₂(NMC811) as cathode electrodes, Li laminated on Cu foil as anode electrodes, and polyolefin film as a separator.

Battery Y is expected to perform similar to Battery B.

### Example 2—Testing Electrochemical Devices

The batteries as disclosed above, Battery A and B, were tested as follows.

Cycling performance: A battery with a cathode, an anode, a separator, and an electrolyte was discharged and charged between various voltage ranges at room temperature using a Neware tester with various current rates. Cycle life is determined by the number of cycles for the battery cell to reach 80% of its original capacity (capacity retention).

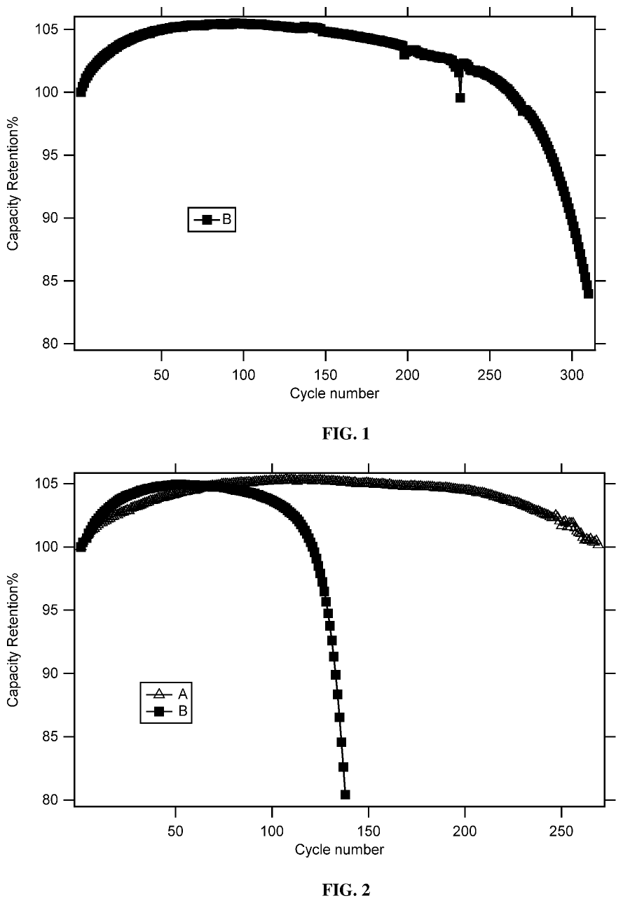

Asymmetric Cycling Test: Each battery was cycled from 2.8 V to 4.25 V (a state-of-charge (SOC) of 0% to 100%) until each battery effectively deteriorates to deliver only 80% of its initial capacity and the number of cycles is measured. The charge current used for this test was 1 mA/cm² and the discharge current used for this test was 3 mA/cm². Table 2 below and FIG. 1 depicts asymmetric cycling data from Battery A. As can be seen in Table 2 below and FIG. 1, Battery B showed over 300 cycles before reaching 80% capacity retention.

Symmetric Cycling Test: Each battery was cycled from 2.8 V to 4.25 V (a state-of-charge (SOC) of 0% to 100%) until each battery effectively deteriorates to deliver only 80% of its initial capacity and the number of cycles is measured. The charge current used for this test was 1 mA/cm² and the discharge current used for this test was 1 mA/cm². Table 2 below and FIG. 2 depict symmetric cycling data from each of the batteries tested. As can be seen in Table 2 below and FIG. 2, Battery A and B showed over 130 cycles before reaching 80% capacity retention.

Low-Temperature Testing: Each battery was tested for their capacity retention at temperatures in a range of 25° C. to −20° C. The batteries were charged to 100% SOC at 25° C. at a charge rate of 0.3 mA/cm²nd are left at 25° C., 10° C., 0° C., −10° C., and −20° C. for 12 hours before discharging and recording the capacity retention of each battery. The discharge rate was 1 mA/cm². According to Table 3, both Battery A and B remained over 70% capacity at −10° C. At −20° C., battery B unexpectedly exhibited a capacity retention rate higher than 70% while battery A had only 1%. It clearly demonstrated the effectiveness of the added fluorinated ether solvent.

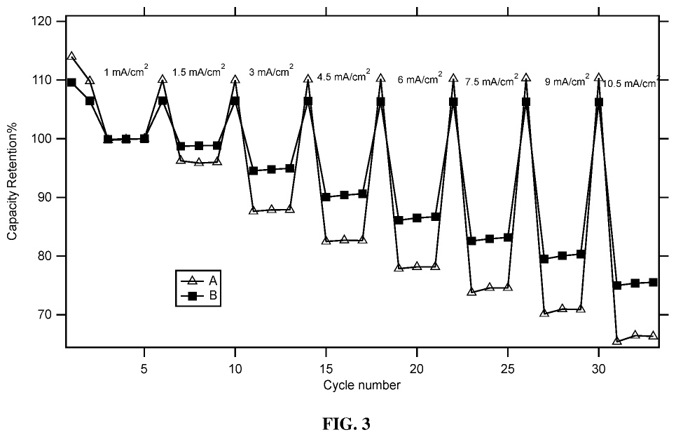

Rate Testing: Each battery was tested for their charge rate capacity and capacity retention. Table 2 below and FIG. 3 depict the rate testing data from each of the batteries tested. As can be seen in Table 2 below and FIG. 3, Battery A and Battery B showed that even at a high current density higher than 10 mA/cm², they can keep a high capacity retention of at least 60%.

TABLE 2

| | Symmetric cycling | Asymmetric Cycling | Charge current |
|---|---|---|---|
| Battery | life (cycles) | life (cycles) | density (mA/cm²) |
| A | 260 | Not measured | 10.5 |
| B | 135 | 350 | 10.5 |

TABLE 3

Capacity retention (%)

| | | |
|---|---|---|
| Temperature | Battery A | Battery B |

| | | | |
|---|---|---|---|
| 25° | C. | 100 | 100 |
| 10° | C. | 91 | 92 |
| 0° | C. | 84 | 88 |
| −10° | C. | 75 | 85 |
| −20° | C. | 1 | 79 |

### Example 3: Safety Testing

Overcharge Test: Battery A and Battery B were tested for their safety, according to the European Council for Automotive Research (EUCAR) hazard levels shown in Table 1 above, based on overcharging each battery. To overcharge the batteries, each battery is charged to 100% SOC and is charged further at a current of 3 mA/cm² for 1 hour (200% SOC) or 8.5V, whichever happened earlier. Table 4 below shows the overcharge test results for each battery.

Hotbox Test: Battery A and Battery B were tested for their safety, according to EUCAR hazard levels shown in Table 1 above, based on over-heating each battery. To over-heat the batteries, each battery was heated from room temperature to 193° C. at a rate of 5° C./minute, and is paused for 10 minutes at temperatures of 133° C., 143° C., 153° C., 163° C., 173° C., 183° C., and 193° C. Table 4 below shows the hotbox test results for each battery.

TABLE 4

| | | Weight loss (% of total | |
|---|---|---|---|
| Battery | Safety Test | electrolyte weight) | EUCAR hazard level |
| A | Overcharge | 1.6 | 3 |
| A | Hotbox | 55 | 4 |
| B | Overcharge | 0.8 | 3 |
| B | Hotbox | 80 | 4 |

The batteries were considered to pass the safety testing if the EUCAR hazard level was 4 or less (e.g., 0, 1, 2, 3, or 4). A EUCAR hazard level of 5 or more was considered a failing safety test. The battery safety testing results are shown in Table 4. Both Battery A and Battery B demonstrated a EUCAR hazard level of 4 or below in hotbox test as well as overcharge test.

### Example 4: Concentration Study

Preparation of a Coin Cell with Various Concentrations of Ether Electrolyte

LiFSI and 1,2-diethoxyethane were mixed to serve as base solution. 1.5 wt % pentaerythritol tetraacrylate (PETA) and 0.1 wt % AIBN were added to the base solution. The base solution was thoroughly mixed for 30 minutes to form a homogeneous solution. The homogenous solution was injected into a coin cell and was let sit for 48 hours at room temperature to allow the homogenous solution to be evenly distributed in the coin cell. Then the coin cell was left in the oven at 65° C. for 2 hours to enable thermal crosslinking. The LiFSI and 1,2-diethoxyethane weight percentages vary from cell 4-1 to 4-7 shown in Table 5. The coin cell included LiNi_{0.8}Co_{0.1}Mn_{0.1}O₂(NMC811) as cathode electrodes, Li laminated on Cu foil as anode electrodes, and polyolefin film as a separator.

TABLE 5

| Cell | 4-1 | 4-2 | 4-3 | 4-4 | 4-5 | 4-6 | 4-7 |
|---|---|---|---|---|---|---|---|
| LiFSI (wt %) | 46.3 | 49.2 | 51.8 | 54.1 | 56.2 | 58.1 | 59.9 |
| 1,2-diethoxyethane | 52.1 | 49.2 | 46.6 | 44.3 | 42.2 | 40.3 | 38.5 |
| (wt %) | | | | | | | |
| PETA (wt %) | 1.5 | 1.5 | 1.5 | 1.5 | 1.5 | 1.5 | 1.5 |
| AIBN (wt %) | 0.1 | 0.1 | 0.1 | 0.1 | 0.1 | 0.1 | 0.1 |

As shown in Table 6 below, it was found that all the cells show a capacity over 160 mAh/g at a discharge rate of 1.5 mA/cm². It was also found that higher concentrations of LiFSI in 1,2-diethoxyethane (e.g., 5M or more) had improved Coulombic efficiency (CE) in Li—Cu and therefore, would have better stability when in contact with lithium metal.

TABLE 6

| Cell | 4-1 | 4-2 | 4-3 | 4-4 | 4-5 | 4-6 | 4-7 |
|---|---|---|---|---|---|---|---|
| CE (%) | 98.5 | 98.8 | 98.8 | 98.81 | 98.87 | 99.0 | 99.02 |
| Capacity (mAh/g) | 177.82 | 174.09 | 173.38 | 168.89 | 168.47 | 163.22 | 161.69 |

### Example 5: Non-Fluorinated Ether:Fluorinated Ether Ratio Study

Multiple coin cells were prepared following the procedure of Example 4, however, each coin cell was prepared with a different amount of fluorinated ether: bis(2,2,2-trifluoroethoxy)methane (BTFM), and non-fluorinated ether: 1,2-diethoxyethane (DEE). The polymer electrolyte compositions for each coin cell are shown in Table 7 below. Each coin cell was tested for viscosity, ionic conductivity (IC), Coulombic efficiency (CE), and capacity. As shown in Table 8 below, it was found that the coin cells were functional with a fluorinated ether percentage of 0% to at least 90%.

TABLE 7

| Cell | 5-1 | 5-2 | 5-3 | 5-4 | 5-5 | 5-6 | 5-7 | 5-8 | 5-9 | 5-10 |
|---|---|---|---|---|---|---|---|---|---|---|
| LIFSI | 51.8 | 46.6 | 41.4 | 36.2 | 31.1 | 25.9 | 20.7 | 15.5 | 10.4 | 5.2 |
| (wt %) | | | | | | | | | | |
| DEE | 46.6 | 42.0 | 37.3 | 32.6 | 28.0 | 23.3 | 18.6 | 14.0 | 9.3 | 4.7 |
| (wt %) | | | | | | | | | | |
| BTFM | 0.0 | 9.8 | 19.7 | 29.5 | 39.4 | 49.2 | 59.0 | 68.9 | 78.7 | 88.6 |
| (wt %) | | | | | | | | | | |
| PETA | 1.5 | 1.5 | 1.5 | 1.5 | 1.5 | 1.5 | 1.5 | 1.5 | 1.5 | 1.5 |
| (wt %) | | | | | | | | | | |
| AIBN | 0.1 | 0.1 | 0.1 | 0.1 | 0.1 | 0.1 | 0.1 | 0.1 | 0.1 | 0.1 |
| (wt %) | | | | | | | | | | |

TABLE 8

| Cell | 5-1 | 5-2 | 5-3 | 5-4 | 5-5 | 5-6 | 5-7 | 5-8 | 5-9 | 5-10 |
|---|---|---|---|---|---|---|---|---|---|---|
| Viscosity | 34.4 | 25.95 | 18.0 | 13.2 | 8.85 | 8.4 | 5.85 | 4.65 | 3.9 | 3.75 |
| at 25° C. (cP) | | | | | | | | | | |
| Viscosity | 179.8 | 87.2 | 66.2 | 40.0 | 26.0 | 12.0 | 10.4 | 8.8 | 5.8 | 5.0 |
| at −20° C. (cP) | | | | | | | | | | |
| IC at 25° C. | 4.48 | 4.04 | 4.49 | 4.46 | 3.06 | 3.16 | 2.71 | 2.21 | 1.67 | 1.72 |
| (mS/cm) | | | | | | | | | | |
| IC at −20° C. | 0.72 | 0.71 | 0.93 | 0.96 | 0.71 | 0.70 | 0.83 | 0.87 | 0.56 | 0.50 |
| (mS/cm) | | | | | | | | | | |
| CE (%) | 99.47 | 99.43 | 99.43 | 99.53 | 99.63 | 99.63 | 99.38 | 99.42 | 99.59 | 99.44 |
| Capacity | 160.63 | 166.28 | 166.73 | 167.23 | 172.50 | 172.80 | 175.0 | 175.9 | 169.23 | 173.7 |
| (mAh/g) * | | | | | | | | | | |

* it was tested at a discharge rate of 1.5 mA/cm².

Viscosity Measurement: Dynamic viscosity was measured by a viscometer at 150 rpm. The viscosity decreased as BTFM percentage increased. A low viscosity can be beneficial for the electrolyte to wet the cathode electrode and the separator.

Contact Angle Measurement: One drop of the polymer electrolyte composition from cell 1 to 6 in Example 5 was dropped on cathode electrode or separator. The contact angle was then measured. The contact angle decreased as BTFM percentage increased, demonstrating the effectiveness of BTFM to improve wetting.

TABLE 9

| | 5-1 | 5-2 | 5-3 | 5-4 | 5-5 | 5-6 |
|---|---|---|---|---|---|---|
| Contact angle on cathode (degrees) | 41 | 40 | 37 | 35 | 26 | 23 |
| Contact angle on separator (degrees) | 40 | 35 | 32 | 27 | 12 | 0 |

Across the BTFM percentage from 0% to at least 90%, DEE-BTFM mixture electrolyte showed a high ionic conductivity (IC) greater than 1.5 mS/cm at 25° C., high IC greater than 0.5 mS/cm at −20° C., high CE higher than 99%, and specific capacity greater than 160 mAh/g at a discharge rate of 1.5 mA/cm².

### Example 6: Fluorinated Ether Example

Multiple coin cells were prepared following the procedure of Example 4 except that a different fluorinated ether: tris(2,2,2-trifluoroethyl)orthoformate (TFEO) was used. The electrolyte compositions for each coin cell are shown in Table 10 below. Each coin cell was tested for ionic conductivity and Coulombic efficiency. The results are shown in Table 11 below.

TABLE 10

| Cell | LiFSI (wt %) | DEE (wt %) | TFEO (wt %) |
|---|---|---|---|
| 6-1 | 36.2 | 32.6 | 29.5 |
| 6-2 | 31.8 | 28.6 | 38.0 |

TABLE 11

| Cell | 6-1 | 6-2 |
|---|---|---|
| IC at 25° C. (mS/cm) | 3.45 | 2.95 |
| CE (%) | 99.34 | 99.27 |

### Example 7: Fluorinated Ether Example

Multiple coin cells were prepared following the procedure of Example 4 except that a different fluorinated ether: 1,2-(1,1,2,2-tetrafluoroethoxy)ethane (TFEE) was used. The polymer electrolyte compositions for each coin cell are shown in Table 12. Each coin cell was tested for IC and CE with the results shown in Table 13.

TABLE 12

| | | | | PETA | AIBN |
|---|---|---|---|---|---|
| Cell | LiFSI (wt %) | DEE (wt %) | TFEE (wt %) | (wt %) | (wt %) |
| 7-1 | 36.2 | 32.6 | 29.5 | 1.5 | 0.1 |
| 7-2 | 25.9 | 23.3 | 49.2 | 1.5 | 0.1 |

TABLE 13

| Cell | 7-1 | 7-2 |
|---|---|---|
| IC at 25° C.(mS/cm) | 3.71 | 3.41 |
| CE (%) | 99.29 | 99.38 |

### Example 8: Initiator Ratio Study

Multiple coin cells were prepared following the procedure of Example 4 except that a different amount of AIBN was used. The polymer electrolyte compositions for each coin cell are shown in Table 14 while the IC and CE results are shown in Table 15.

TABLE 14

| | | | | PETA | AIBN |
|---|---|---|---|---|---|
| Cell | LiFSI (wt %) | DEE (wt %) | BTFM (wt %) | (wt %) | (wt %) |
| 8-1 | 36.2 | 32.6 | 29.5 | 1.5 | 0.2 |
| 8-2 | 36.2 | 32.5 | 29.5 | 1.5 | 0.3 |
| 8-3 | 36.0 | 32.5 | 29.4 | 1.5 | 0.5 |

TABLE 15

| Cell | 8-1 | 8-2 | 8-3 |
|---|---|---|---|
| IC at 25° C. (mS/cm) | 3.64 | 3.40 | 4.03 |
| CE (%) | 99.30 | 99.35 | 99.14 |

### Example 9: Li Salt Study

Multiple coin cells were prepared following the procedure of Example 4 except that a mixture of LiFSI and LiTFSI was used as Li salt. The polymer electrolyte compositions for each coin cell are shown in Table 16 below and the CE of coin cell was tested and shown in Table 17 below.

TABLE 16

| | LiFSI | LiTFSI | DEE | BTFM | PETA | AIBN |
|---|---|---|---|---|---|---|
| Cell | (wt %) | (wt %) | (wt %) | (wt %) | (wt %) | (wt %) |
| 9-1 | 35.4 | 0.8 | 32.6 | 29.5 | 1.5 | 0.1 |
| 9-2 | 34.2 | 2.0 | 32.6 | 29.5 | 1.5 | 0.1 |
| 9-3 | 32.3 | 3.9 | 32.6 | 29.5 | 1.5 | 0.1 |

TABLE 17

| Cell | 9-1 | 9-2 | 9-3 |
|---|---|---|---|
| CE (%) | 99.42 | 99.47 | 99.43 |

### Example 10

Preparation of a Coin Cell with High Concentration Ether Electrolyte (Battery 10-1)

46 wt % LiFSI, 8 wt % LiTFSI and 46 wt % 1,2-diethoxyethane were mixed for 30 minutes to form a homogeneous solution. The homogenous solution was injected into a coin cell and was let sit for 48 hours at room temperature to allow the homogenous solution to be evenly distributed in the coin cell. The coin cell included LiNi_{0.8}Co_{0.1}Mn_{0.1}O₂(NMC811) as cathode electrodes, Li laminated on Cu foil as anode electrodes, and polyolefin film as a separator.

Preparation of a Coin Cell with High Concentration Ether-Fluorinated Ether Electrolyte (10-2)

13 wt % LiFSI, 12 wt % 1,2-diethoxyethane and 75 wt % 1,1,1,3,3,3-Hexafluoro-2-{[(1,1,1,3,3,3-hexafluoro-2-propanyl)oxy]methoxy}propane were mixed for 30 minutes to form a homogeneous solution. The homogenous solution was injected into a coin cell and was let sit for 48 hours at room temperature to allow the homogenous solution to be evenly distributed in the coin cell. The coin cell included LiNi_{0.8}Co_{0.1}Mn_{0.1}O₂(NMC811) as cathode electrodes, Li laminated on Cu foil as anode electrodes, and polyolefin film as a separator.

TABLE 18

| Cell | 10-1 | 10-2 |
|---|---|---|
| Viscosity at 25° C. (cP) | 41.4 | 8.85 |
| IC at 25° C. (mS/cm) | 3.99 | 1.94 |
| CE (%) | 98.96 | 99.18 |
| Discharge capacity at 1.5 mA/cm² (mAh/g) | 171.03 | 161.71 |

Table 18 indicates that incorporating fluorinated ether into the electrolyte reduced the viscosity and increased the coulombic efficiency. The reduced ionic conductivity may be ascribed to the decreased concentration of the lithium salt. Battery 10-2 is expected to exbibit an improved thermal stability and flame resistance in comparison to battery 10-1.

Various embodiments of the features of this disclosure are described herein. However, it should be understood that such embodiments are provided merely by way of example, and numerous variations, changes, and substitutions can occur to those skilled in the art without departing from the scope of this disclosure. It should also be understood that various alternatives to the specific embodiments described herein are also within the scope of this disclosure.

### ASPECTS

In a first aspect of the disclosure, a polymer electrolyte composition comprises: an electrolyte salt; a polymer; and a solvent comprising a fluorinated ether and a non-fluorinated ether.

In a second aspect of the disclosure, a polymer electrolyte composition comprises: an electrolyte salt; a polymer; and a solvent comprising a non-fluorinated ether, wherein the electrolyte salt is present in an amount of about 30 wt % to about 75 wt %, based on the weight of the non-fluorinated ether.

In a third aspect of the disclosure, an electrolyte composition comprises: an electrolyte salt; and a solvent comprising a fluorinated ether and a non-fluorinated ether, wherein the fluorinated ether has a boiling point of at least 100° C. at 1 atm.

In a fourth aspect according to any preceding aspect, the non-fluorinated ether is a compound of Formula (I): R^{1a}—O—R^{2a} (I), wherein R^{1a} is C₁-C₁₀ alkyl; R^{2a} is —(CH₂)ₙ—O—(C₁-C₁₀ alkyl) or C₁-C₁₀ alkyl; or R^{1a} and R^{2a}, together with the oxygen atom to which they are attached form a 4-7 membered heterocyclyl; and n is an integer and is 1 or 2.

In a fifth aspect according to any preceding aspect, the non-fluorinated ether comprises one or more of 1,2-dimethoxyethane, 1,2-diethoxyethane, 1,2-dibutoxyethane, diethyl ether, dibutylether, di-tert-butyl ether, tert-butyl ethyl ether, tert-butyl methyl ether, 1,3-dioxolane, 1,4-dioxane, di(propylene glycol) methyl ether.

In a sixth aspect according to any preceding aspect, the non-fluorinated ether comprises 1,2-diethoxyethane.

In a seventh aspect according to the first or third through sixth aspects, the fluorinated ether is a compound of Formula (II):

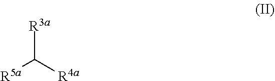

wherein R^{3a} is H, C₁-C₁₀ alkyl, C₁-C₁₀ fluoroalkyl, —O—(C₁-C₁₀ alkyl) or —O—(C₁-C₁₀ fluoroalkyl); R^{4a} and R^{5a} each independently are C₁-C₁₀ alkyl, C₁-C₁₀ fluoroalkyl, —O—(C₁-C₁₀ alkyl) or —O—(C₁-C₁₀ fluoroalkyl); and at least one of R^{3a}, R^{4a}, and R^{5a} is —O—(C₁-C₁₀ alkyl) or —O—(C₁-C₁₀ fluoroalkyl), and at least one of R^{3a}, R^{4a}, and R^{5a} comprises a C₁-C₁₀ fluoroalkyl.

In an eighth aspect according to the seventh aspect, the fluorinated ether comprises one or more of bis(2,2,2-trifluoroethoxy)methane (BTFM), 1,1,1,3,3,3-hexafluoro-2-(1,1,1,3,3,3-hexafluoropropan-2-yloxymethoxy)propane, bis(3,3,3-trifluoropropoxy)methane, 1,1,1-trifluoro-3-[(2,2,2-trifluoroethoxy)methoxy]propane, bis(2,2,3,3,3-pentafluoropropoxy)methane, and 1,1,1,2,2-pentafluoro-3-((2,2,2-trifluoroethoxy)methoxy)propane, 1,1,2,2-tetrafluoroethyl-2,2,3,3-tetrafluoropropyl ether (TTE), 1H,1H,5H-octafluoropentyl-1,1,2,2-tetrafluoroethyl ether (OTE), Bis(2,2,2-trifluoroethyl) ether, 1H,1H,2′H-Perfluorodipropyl ether, 2,2,2-Trifluoroethyl 1,1,2,2-tetrafluoroethyl ether, 1,2-(1,1,2,2-Tetrafluoroethoxy)ethane (TFEE), and tris(2,2,2-trifluoroethyl)orthoformate (TFEO).

In a ninth aspect according to the first or third through sixth aspect, the fluorinated ether is a compound of Formula (II):

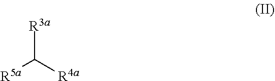

wherein R^{3a} is H, —O—(C₁-C₁₀ alkyl) or —O—(C₁-C₁₀ fluoroalkyl); and R^{4a} and R^{5a} each independently are —O—(C₁-C₁₀ alkyl) or —O—(C₁-C₁₀ fluoroalkyl).

In a tenth aspect according to the ninth aspect, the fluorinated ether comprises one or more of bis(2,2,2-trifluoroethoxy)methane (BTFM) or tris(2,2,2-trifluoroethyl)orthoformate (TFEO).

In an eleventh aspect according to the first or third through tenth aspect, the solvent comprises the fluorinated ether in an amount in a range of 0.1 wt % to about 99 wt %, or about 10 wt % to about 90 wt %, about 20 wt % to about 80 wt %, about 25 wt % to about 75 wt %, or about 55 wt % to about 75 wt %.

In a twelfth aspect according to the first or third through eleventh aspect, the solvent comprises the non-fluorinated ether in an amount in a range of 0.1 wt % to about 99 wt %, or about 10 wt % to about 90 wt %, about 20 wt % to about 80 wt %, about 25 wt % to about 70 wt %, or about 25 wt % to about 45 wt %.

In a thirteenth aspect according to the first or third through twelfth aspect, wherein the non-fluorinated ether and the fluorinated ether are present in a weight ratio of 1:20 to 20:1, 1:10 to 10:1, 1:5 to 10:1, 1:3 to 8:1, or 1:1 to 3:1.

In a fourteenth aspect according to the second aspect, the nonfluorinated ether in the solvent is 1,2-diethoxyethane.

In a fifteenth aspect according to any preceding aspect, the solvent is present in an amount of at least 85 wt %, at least about 90 wt %, at least about 95 wt %, or at least about 98 wt %, or in a range of about 85 wt % to about 99 wt %, about 90 wt % to about 99 wt %, based on the total weight of the electrolyte composition.

In a sixteenth aspect according to any preceding aspect, the solvent is substantially free of 1,2-dimethoxyethane.

In a seventeenth aspect according to any preceding aspect, the solvent has a boiling point of at least 100° C. at 1 atm.

In an eighteenth aspect according to any preceding aspect, the electrolyte salt comprises one or more of lithium perchlorate (LiClO₄), lithium nitrate (LiNO₃), lithium hexafluorophosphate (LiPF₆), lithium borofluoride (LiBF₄), lithium hexafluoroarsenide (LiAsF₆), lithium trifluorometasulfonate (LiCF₃SO₃), lithium bisperfluoro-ethysulfonylimide (LiBETI), lithium bis(fluorosulfonyl)imide (LiFSI), lithium bis(trifluoromethanesulfonyl)imide (LiN(CF₃SO₂)₂, LiTFSI), lithium bis(oxalato)borate (LiBOB), lithium difluoro(oxalato)borate (LiBF₂C₂O₄, LiDFOB), lithium fluoroalkyl-phosphates (Li[PFₓ(C_{y}F_{2y+1-z}H_{z})₆₋ₓ]) (1≤x≤5, 1≤y≤8, and 0≤z≤2y−1), lithium fluorophosphate (Li₂PO₃F), lithium difluorophosphate (LiDFP), lithium difluoro(bisoxalato)phosphate (LiC₄PO₈F₂), and lithium tetrafluoro oxalato phosphate (LiC₂PO₄F₄), lithium tris(trifluoromethanesulfonyl)methide (LiC(CF₃SO₂)₃), LiF, LiCl, LiBr, LiI, Li₂SO₄, Li₃PO₄, Li₂CO₃, LiOH, lithium acetate, lithium trifluoromethyl acetate, and lithium oxalate.

In nineteenth aspect according to the eighteenth aspect, the electrolyte salt comprises one or more of lithium bis(fluorosulfonyl)imide (LiFSI), lithium trifluoromethanesulfonimide (LiTFSI), and lithium difluororphosphate.

In a twentieth aspect according to any preceding aspect, the electrolyte salt is present in the polymer electrolyte composition in an amount of about 5 wt % to about 75 wt %, or about 15 wt % to about 75 wt %, or about 25 wt % to about 75 wt %, or about 30 wt % to about 70 wt %, or about 40 wt % to about 60 wt %, or about 15 wt % to about 50 wt %, based on the total weight of the polymer electrolyte composition.

In a twenty-first aspect according to any preceding aspect, the polymer is crosslinked and has a heterogeneous polymer network obtained from a crosslinking reaction of a composition comprising one or more crosslinkers.

In a twenty-second aspect according to the twenty-first aspect, at least one of the one or more crosslinkers has three or more polymerizable or crosslinkable terminals.

In a twenty-third aspect according to any preceding aspect, the polymer is present in an amount of about 0.1 wt % to about 10 wt %, about 0.5 wt % to about 5 wt %, or about 0.5 wt % to about 2.5 wt %.

In a twenty-fourth aspect, disclosed is an electrochemical device comprising the polymer electrolyte composition of any of the preceding aspects.

In a twenty-fifth aspect according to the twenty-fourth aspect, the electrochemical device further comprises an anode, wherein the anode is a carbon anode, Li anode, Si anode, alloy anode, Li₄Ti₅O₁₂, or made from conversion anode materials.

In a twenty-sixth aspect according to the twenty-fifth aspect, the carbon anode comprises graphite, soft carbon, hard carbon, or combinations thereof.

In a twenty-seventh aspect according to the twenty-fifth aspect, the Li anode comprises Li metal foil or Li metal on Cu, Ni, or stainless steel.

In a twenty-eighth aspect according to the twenty-fifth aspect, the Si anode comprises Si, Si/Carbon composite, SiOₓ (0≤x≤2), SiOₓ (0≤x≤2)/carbon composite or a combination thereof.

In a twenty-ninth aspect according to the twenty-fifth aspect, the alloy anode comprises Sn, SnO₂, Sb, Al, Mg, Bi, In, As, Zn, Ga, B, or a combination thereof.

In a thirtieth aspect according to the twenty-fifth aspect, the conversion anode materials comprise MₐX_{b}, wherein M is Mn, Fe, Co, Ni, or Cu, X is O, S, Se, F, N, or P, and a and b are each independently in a range of 1 to 4.

In a thirty-first aspect according to the twenty-fifth aspect, the anode is Li metal foil or Li metal on Cu, Ni, or stainless steel.

In a thirty-second aspect according to any of the twenty-fourth through thirty-first aspects, the electrochemical device passes an overcharge test, wherein the electrochemical device is at 100% state-of-charge and is overcharged at a 3 mA/cm² charge rate for 1 hour or when 8.5V is reached with a European Council for Automotive Research (EUCAR) hazard level of 4 or below.

In a thirty-third aspect according to any of the twenty-fourth through thirty-second aspects, the electrochemical device passes a hotbox test, wherein the electrochemical device is at 100% state-of-charge and is held at each of the following temperatures: 130° C., 140° C., 150° C., 160° C., 170° C., 180° C., and 190° C. for 10 minutes with a European Council for Automotive Research (EUCAR) hazard level of 4 or below.

In a thirty-fourth aspect according to any of the twenty-fourth through thirty-third aspects, the electrochemical device maintains a specific capacity of at least 160 mAh/g for at least 200 asymmetric cycles, or at least 220 asymmetric cycles, or at least 250 asymmetric cycles, wherein the charge current is 1 mA/cm² and the discharge current is 3 mA/cm².

In a thirty-fifth aspect according to any of the twenty-fourth through thirty-fourth aspects, the electrochemical device maintains a specific capacity of at least 140 mAh/g for at least 120 symmetric cycles, or at least 130 symmetric cycles, or at least 135 symmetric cycles, wherein the charge current and discharge current is 1 mA/cm².

In a thirty-sixth aspect according to any of the twenty-fourth through thirty-fifth aspects, the electrochemical device has a charge current density of at least about 10 mA/cm², at least about 15 mA/cm², at least about 18 mA/cm², or about 10 mA/cm² to about 18 mA/cm².

In a thirty-seventh aspect according to any of the twenty-fourth through thirty-sixth aspects, the electrochemical device has a capacity retention of at least 50%, at least 60%, at least 70%, or at least 80% at a temperature in a range of 0° C. to −20° C., or −10° C. to −20° C. for at least 3 hours, at least 6 hours, or at least 12 hours.

In a thirty-eighth aspect disclosed is an electrochemical device comprising: an anode; a cathode; and an electrolyte composition comprising: an electrolyte salt; and a solvent comprising a non-fluorinated ether; wherein the electrochemical device has a capacity retention of at least 70% at a temperature in a range of −10° C. to −20° C. for at least 6 hours.

In a thirty-ninth aspect according to the thirty-eighth aspect, the solvent further comprises a fluorinated ether.

In a fortieth aspect, according to the thirty-eighth or thirty-ninth aspect, the electrolyte further comprises a polymer.

In a forty-first aspect, disclosed is an electrochemical device comprising: an anode; a cathode; and an electrolyte composition comprising: an electrolyte salt; and a solvent comprising a non-fluorinated ether; wherein the electrochemical device passes a hotbox test, wherein the electrochemical device is at 100% state-of-charge and is held at each of the following temperatures: 130° C., 140° C., 150° C., 160° C., 170° C., 180° C., and 190° C. for 10 minutes with a European Council for Automotive Research (EUCAR) hazard level of 4 or below.

In a forty-second aspect according to the forty-first aspect, the solvent further comprises a fluorinated ether.

In a forty-third aspect according to the forty-first or forty-second aspect, the electrolyte further comprises a polymer.

In a forty-fourth aspect, disclosed is an electrochemical device comprising: an anode; a cathode; and an electrolyte composition comprising: an electrolyte salt; and a solvent comprising a non-fluorinated ether; wherein the electrochemical device passes an overcharge test, wherein the electrochemical device is at 100% state-of-charge and is overcharged at a 3 mA/cm² charge rate for 1 hour or when 8.5V is reached with a European Council for Automotive Research (EUCAR) hazard level of 4 or below.

In a forty-fifth aspect according to the forty-fourth aspect, the solvent further comprises a fluorinated ether.

In a forty-sixth aspect according to the forty-fourth or forty-fifth aspect, the electrolyte further comprises a polymer.

In a forty-seventh aspect, disclosed is an electrochemical device comprising: an anode; a cathode; and an electrolyte composition comprising: an electrolyte salt; and a solvent comprising a non-fluorinated ether; wherein the electrochemical cell has a charge current density in a range of about 10.5 mAh/cm² to about 16.5 mAh/cm².

In a forty-eighth aspect according to the forty-seventh aspect, the solvent further comprises a fluorinated ether.

In a forty-ninth aspect according to the forty-seventh or forty-eighth aspect, the electrolyte further comprises a polymer.

In a fiftieth aspect according to any of the thirty-eighth through forty-ninth aspects, the fluorinated ether has a boiling point of at least 100° C. at 1 atm.

In a fifty-first aspect according to the fiftieth aspect, wherein the fluorinated ether is a compound of Formula (II):

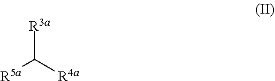

wherein R^{3a} is H, —O—(C₁-C₁₀ alkyl) or —O—(C₁-C₁₀ fluoroalkyl); and R^{4a} and R^{5a} each independently are —O—(C₁-C₁₀ alkyl) or —O—(C₁-C₁₀ fluoroalkyl).

We claim:

1. A polymer electrolyte composition comprising:
an electrolyte salt;
a polymer; and
a solvent comprising a fluorinated ether and a non-fluorinated ether.

2. The composition of claim 1, wherein the non-fluorinated ether is a compound of Formula (I):
R^{1a}—O—R^{2a} (I),
wherein R^{1a} is C₁-C₁₀ alkyl; R^{2a} is —(CH₂)ₙ—O—(C₁-C₁₀ alkyl) or C₁-C₁₀ alkyl; or R^{1a} and R^{2a}, together with the oxygen atom to which they are attached form a 4-7 membered heterocyclyl; and n is an integer and is 1 or 2.

3. The composition of claim 1, wherein the non-fluorinated ether comprises at least one selected from the group consisting of 1,2-dimethoxyethane, 1,2-diethoxyethane, 1,2-dibutoxyethane, diethyl ether, dibutylether, di-tert-butyl ether, tert-butyl ethyl ether, tert-butyl methyl ether, 1,3-dioxolane, 1,4-dioxane, di(propylene glycol) methyl ether and mixtures thereof.

4. The composition of claim 1, wherein the fluorinated ether is a compound of Formula (II): 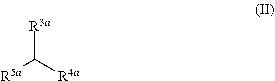
wherein R^{3a} is H, C₁-C₁₀ alkyl, C₁-C₁₀ fluoroalkyl, —O—(C₁-C₁₀ alkyl) or —O—(C₁-C₁₀ fluoroalkyl); R^{4a} and R^{5a} each independently are C₁-C₁₀ alkyl, C₁-C₁₀ fluoroalkyl, —O—(C₁-C₁₀ alkyl) or —O—(C₁-C₁₀ fluoroalkyl); and wherein at least one of R^{3a}, R^{4a}, and R^{5a} is —O—(C₁-C₁₀ alkyl) or —O—(C₁-C₁₀ fluoroalkyl), and at least one of R^{3a}, R^{4a}, and R^{5a} comprises a C₁-C₁₀ fluoroalkyl.

5. The composition of claim 1, wherein the fluorinated ether is a compound with Formula (II): 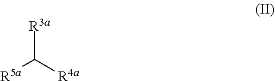
wherein R^{3a} is H, —O—(C₁-C₁₀ alkyl) or —O—(C₁-C₁₀ fluoroalkyl); and
R^{4a} and R^{5a} each independently are —O—(C₁-C₁₀ alkyl) or —O—(C₁-C₁₀ fluoroalkyl).

6. The composition of claim 1, wherein the fluorinated ether comprises at least one selected from the group consisting of bis(2,2,2-trifluoroethoxy)methane (BTFM), 1,1,1,3,3,3-hexafluoro-2-(1,1,1,3,3,3-hexafluoropropan-2-yloxymethoxy)propane, bis(3,3,3-trifluoropropoxy)methane, 1,1,1-trifluoro-3-[(2,2,2-trifluoroethoxy)methoxy]propane, bis(2,2,3,3,3-pentafluoropropoxy)methane, and 1,1,1,2,2-pentafluoro-3-((2,2,2-trifluoroethoxy)methoxy)propane, 1,1,2,2-tetrafluoroethyl-2,2,3,3-tetrafluoropropyl ether (TTE), 1H,1H,5H-octafluoropentyl-1,1,2,2-tetrafluoroethyl ether (OTE), Bis(2,2,2-trifluoroethyl) ether, 1H,1H,2′H-Perfluorodipropyl ether, 2,2,2-Trifluoroethyl 1,1,2,2-tetrafluoroethyl ether, 1,2-(1,1,2,2-Tetrafluoroethoxy)ethane (TFEE), and tris(2,2,2-trifluoroethyl)orthoformate (TFEO), and mixtures thereof.

7. The composition of claim 1, wherein the solvent comprises the fluorinated ether in an amount in a range from about 10 wt % to about 90 wt %.

8. The composition of claim 1, wherein the non-fluorinated ether and the fluorinated ether are present in a weight ratio in a range from 1:20 to 20:1.

9. The composition of claim 1, wherein the solvent is present in an amount of at least 85 wt % based on the total weight of the electrolyte composition.

10. The composition of claim 1, wherein the non-fluorinated ether in the solvent has a boiling point of at least 100° C. at 1 atm.

11. The composition of claim 1, wherein the fluorinated ether in the solvent has a boiling point of at least 100° C. at 1 atm.

12. The composition of claim 1, wherein the electrolyte salt comprises at least one selected from the group consisting of lithium perchlorate (LiClO₄), lithium nitrate (LiNO₃), lithium hexafluorophosphate (LiPF₆), lithium borofluoride (LiBF₄), lithium hexafluoroarsenide (LiAsF₆), lithium trifluorometasulfonate (LiCF₃SO₃), lithium bisperfluoro-ethysulfonylimide (LiBETI), lithium bis(fluorosulfonyl)imide (LiFSI), lithium bis(trifluoromethanesulfonyl)imide (LiN(CF₃SO₂)₂, LiTFSI), lithium bis(oxalato)borate (LiBOB), lithium difluoro(oxalato)borate (LiBF₂C₂O₄, LiDFOB), lithium fluoroalkyl-phosphates (Li[PFₓ(C_{y}F_{2y+1-z}H_{z})₆₋ₓ]) (1≤x≤5, 1≤y≤8, and 0≤z≤2y−1), lithium fluorophosphate (Li₂PO₃F), lithium difluorophosphate (LiDFP), lithium difluoro(bisoxalato)phosphate (LiC₄PO₈F₂), and lithium tetrafluoro oxalato phosphate (LiC₂PO₄F₄), lithium tris(trifluoromethanesulfonyl)methide (LiC(CF₃SO₂)₃), LiF, LiCl, LiBr, LiI, Li₂SO₄, Li₃PO₄, Li₂CO₃, LiOH, lithium acetate, lithium trifluoromethyl acetate, and lithium oxalate.

13. The composition of claim 1, wherein the electrolyte salt is present in the electrolyte composition in an amount in a range from about 5 wt % to about 75 wt %, based on the total weight of the electrolyte composition.

14. The composition of claim 1, wherein the polymer is crosslinked and has a heterogeneous polymer network obtained from a crosslinking reaction of a composition comprising one or more crosslinkers each comprising three or more polymerizable or crosslinkable terminals.

15. The composition of claim 1, wherein the polymer is present in an range from about 0.1 wt % to about 10 wt %. in the electrolyte composition.

16. An electrolyte composition comprising:
an electrolyte salt; and
a solvent comprising a fluorinated ether and a non-fluorinated ether,
wherein the fluorinated ether has a boiling point of at least 100° C. at 1 atm, and wherein the fluorinated ether has a Formula (II): 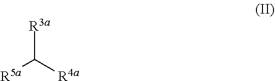
wherein R^{3a} is H, —O—(C₁-C₁₀ alkyl) or —O—(C₁-C₁₀ fluoroalkyl); and
R^{4a} and R^{5a} each independently are —O—(C₁-C₁₀ alkyl) or —O—(C₁-C₁₀ fluoroalkyl).

17. The electrolyte composition of claim 16, wherein the non-fluorinated ether in the solvent has a boiling point of at least 100° C. at 1 atm.

18. An electrochemical device comprising the electrolyte composition of claim 1.

19. The electrochemical device of claim 18, wherein the electrochemical device is featured for at least one of the following characteristics:
a) the electrochemical device passes an overcharge test, wherein the electrochemical device is at 100% state-of-charge and is overcharged at a 3 mA/cm² charge rate for 1 hour or when 8.5V is reached with a European Council for Automotive Research (EUCAR) hazard level of 4 or below;
b) the electrochemical device passes a hotbox test, wherein the electrochemical device is at 100% state-of-charge and is held at each of the following temperatures: 130° C., 140° C., 150° C., 160° C., 170° C., 180° C., and 190° C. for 10 minutes with a European Council for Automotive Research (EUCAR) hazard level of 4 or below;
c) the electrochemical device maintains a specific capacity of at least 160 mAh/g for at least 200 asymmetric cycles, wherein the charge current is 1 mA/cm² and the discharge current is 3 mA/cm²;
d) the electrochemical device maintains a specific capacity of at least 140 mAh/g for at least 120 symmetric cycles, wherein the charge current and discharge current is 1 mA/cm²;
e) the electrochemical device has a charge current density in a range from about 10 mA/cm² to about 18 mA/cm²; and
f) the electrochemical device has a capacity retention of at least 50% at a temperature in a range of 0° C. to −20° C. for at least 3 hours.

20. An electrochemical device comprising the electrolyte composition of claim 16, wherein the electrochemical device is featured for at least one of the following characteristics:
a) the electrochemical device passes an overcharge test, wherein the electrochemical device is at 100% state-of-charge and is overcharged at a 3 mA/cm² charge rate for 1 hour or when 8.5V is reached with a European Council for Automotive Research (EUCAR) hazard level of 4 or below;
b) the electrochemical device passes a hotbox test, wherein the electrochemical device is at 100% state-of-charge and is held at each of the following temperatures: 130° C., 140° C., 150° C., 160° C., 170° C., 180° C., and 190° C. for 10 minutes with a European Council for Automotive Research (EUCAR) hazard level of 4 or below;
c) the electrochemical device maintains a specific capacity of at least 160 mAh/g for at least 200 asymmetric cycles, wherein the charge current is 1 mA/cm² and the discharge current is 3 mA/cm²;
d) the electrochemical device maintains a specific capacity of at least 140 mAh/g for at least 120 symmetric cycles, wherein the charge current and discharge current is 1 mA/cm²;
e) the electrochemical device has a charge current density in a range from about 10 mA/cm² to about 18 mA/cm²; and
f) the electrochemical device has a capacity retention of at least 50% at a temperature in a range of 0° C. to −20° C. for at least 3 hours.
